(19) United States
(12) Patent Application Publication
(10) Pub. No.: US 2026/0103239 A1
(43) Pub. Date: Apr. 16, 2026

(54) CONTROL DEVICE, MOTOR DEVICE, ELECTRIC POWER STEERING DEVICE, CONTROL METHOD, AND PROGRAM

(71) Applicant: NIDEC CORPORATION, Kyoto (JP)

(72) Inventors: Daisuke NOTSU, Kyoto (JP); Shuji ENDO, Kyoto (JP)

(21) Appl. No.: 19/352,662

(22) Filed: Oct. 8, 2025

Related U.S. Application Data
(60) Provisional application No. 63/705,666, filed on Oct. 10, 2024.

(30) Foreign Application Priority Data
Jan. 17, 2025 (JP) 2025-007167

(51) Int. Cl. B62D 15/02; B62D 5/04

(52) U.S. Cl. CPC B62D 15/025; B62D 5/046

(57) ABSTRACT

A control device includes a first assist controller configured or programmed to perform lane keeping control and generate a first input value, a second assist controller configured or programmed to generate a second input value based on a steering input value, and a disturbance sensitivity controller configured or programmed to which a command value calculated based on the first input value and the second input value is input. The first assist controller is configured or programmed to include a generator configured or programmed to generate a first input value based on a target value of an output of a decelerator. A second output value indicating the output of the decelerator is fed back to the generator. The generator is configured or programmed to include a compensator configured or programmed to perform phase delay compensation processing on a phase delay generated in the fed back second output value.

### CROSS-REFERENCE TO RELATED APPLICATIONS

The present application is a non-provisional of U.S. Patent Application No. 63/705,666, filed on Oct. 10, 2024, and claims priority under 35 U.S.C. § 119 to Japanese Patent Application No. 2025-007167, filed on Jan. 17, 2025, the entire contents of which are incorporated herein by reference.

### 1. FIELD OF THE INVENTION

The present disclosure relates to control devices, motor devices, electric power steering devices, control methods, and non-transitory computer-readable media including programs.

### 2. BACKGROUND

Conventionally, an electric power steering system mounted on a vehicle is known.

The electric power steering system as described above may include, for example, a control device capable of executing lane keeping control. The lane keeping control is control that provides driving force to the steering mechanism by the motor to keep the vehicle in a lane when the vehicle is likely to deviate from the lane. In the case where such lane keeping control is performed, there is a technology for realizing the lane keeping control by simple control by constraining the control target to a simple model by means of model following control. In such model following control, for example, disturbance estimation and compensation are performed based on a steering angle. However, when the feedback signal of the steering angle is delayed due to, for example, the length of the communication cycle, the frequency band in which the disturbance can be estimated and compensated for by the model following control is limited, and the responsiveness of the lane keeping control may be deteriorated.

### SUMMARY

A control device according to an example embodiment of the present disclosure controls, as a control target, a portion including a motor and a decelerator in an electric power steering device mounted on a vehicle, the electric power steering device including an input shaft to which a steering wheel to be steered by a steering operator is connected, an output shaft connected to the input shaft via a torsion bar, and the motor connected to the output shaft via the decelerator. The control device includes a first assist controller configured or programmed to execute lane keeping control to keep the vehicle in a lane and generate a first input value, a second assist controller configured or programmed to generate a second input value based on a steering input value input from the steering wheel, and a disturbance sensitivity controller to which a command value calculated based on the first input value and the second input value is input. The disturbance sensitivity controller is configured or programmed to include a model following controller configured or programmed to generate a correction value to correct the command value based on a nominal model based on the configuration of the control target. The model following controller is configured or programmed to include an inverse nominal model that is an inverse model of the nominal model and to which a third input value based on a first output value indicating an output of the motor is input, and is configured or programmed such that a transfer function of the control target is constrained to a transfer function of the nominal model in a frequency band in which a complementary sensitivity gain that is a gain in a gain characteristic of a complementary sensitivity function with respect to a modeling error between the control target and the nominal model, is 1 or substantially 1. The first assist controller is configured or programmed to include a generator configured or programmed to generate the first input value based on a target value of an output of the decelerator. A second output value indicating the output of the decelerator is fed back to the generator. The generator is configured or programmed to include a compensator configured or programmed to perform phase delay compensation processing on a phase delay generated in the fed back second output value.

A motor device according to an example embodiment of the present disclosure includes the control device and the motor according to another example embodiment of the present disclosure.

An electric power steering device according to an example embodiment of the present disclosure includes the motor device according to another example embodiment of the present disclosure, and a steering mechanism including the input shaft, the output shaft, and the torsion bar.

A control method according to an example embodiment of the present disclosure is a method of controlling, as a control target, a portion including a motor and a decelerator of an electric power steering device mounted on a vehicle, the electric power steering device including an input shaft to which a steering wheel to be steered by a steering operator is connected, an output shaft connected to the input shaft via a torsion bar, and the motor connected to the output shaft via the decelerator. The control method includes generating a first input value and executing lane keeping control to keep the vehicle in a lane, generating a second input value based on a steering input value input from the steering wheel, executing a model following control to generate a correction value to correct a command value calculated based on the first input value and the second input value, based on a nominal model based on a configuration of the control target, and constraining a transfer function of the control target to a transfer function of the nominal model in a frequency band in which a complementary sensitivity gain is 1 or substantially 1, the complementary sensitivity gain being a gain in a gain characteristic of a complementary sensitivity function with respect to a modeling error between the control target and the nominal model. In the model following control, a third input value based on a first output value indicating an output of the motor is input to an inverse nominal model that is an inverse model of the nominal model. The lane keeping control includes generating the first input value based on a target value of an output of the decelerator, feeding back a second output value indicating an output of the decelerator, and performing phase delay compensation processing on a phase delay generated in the second output value fed back.

A non-transitory computer-readable medium including a computer program according to an example embodiment of the present disclosure causes a computer to execute the control method described above.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram schematically illustrating an electric power steering device according to a first example embodiment of the present disclosure.

FIG. 2 is a block diagram illustrating a configuration of a control device according to the first example embodiment.

FIG. 3 is a diagram schematically illustrating a case where a vehicle including a lane keeping system according to the first example embodiment travels in a lane.

FIG. 4 is a block diagram illustrating a configuration of the lane keeping system according to the first example embodiment.

FIG. 5 is a block diagram illustrating a configuration of an imaging device and a first assist controller according to the first example embodiment.

FIG. 6 is a diagram for explaining lane keeping control according to the first example embodiment.

FIG. 7 is a block diagram illustrating a configuration of a second assist controller according to the first example embodiment.

FIG. 8 is a graph illustrating an example of a relationship between an input torque and an assist torque according to the first example embodiment.

FIG. 9 is a block diagram illustrating a configuration of a vehicle stabilization controller according to the first example embodiment.

FIG. 10 is a Bode diagram illustrating a gain of a transfer function of a second nominal model according to the first example embodiment.

FIG. 11 is a block diagram illustrating a configuration of a second state feedback loop according to the first example embodiment.

FIG. 12 is a block diagram illustrating a configuration of a disturbance sensitivity controller according to the first example embodiment.

FIG. 13 is a graph exemplifying a gain characteristic of a complementary sensitivity function of a first model following controller and a gain characteristic of a reciprocal of a modeling error between a transfer function of a first control target and a transfer function of a first nominal model according to the first example embodiment.

FIG. 14 is a graph illustrating an example of a relationship between a steering angle and a self-aligning torque.

FIG. 15 is a block diagram illustrating a configuration of a calculator according to the first example embodiment.

FIG. 16 is a graph illustrating an example of a gain of a high-frequency output value and a gain of a low-frequency output value according to the first example embodiment.

FIG. 17 is a block diagram illustrating a configuration of a lane keeping system according to a second example embodiment of the present disclosure.

FIG. 18 is a block diagram illustrating a configuration of a generator according to a third example embodiment of the present disclosure.

### DETAILED DESCRIPTION

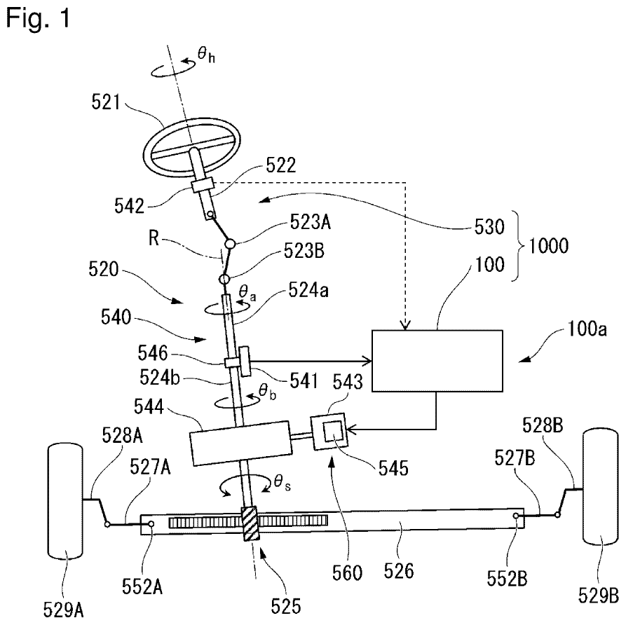

An electric power steering device 1000 of the present example embodiment illustrated in FIG. 1 is mounted on a vehicle V. As illustrated in FIG. 1, the electric power steering device 1000 includes a steering mechanism 530 and a control device 100. The steering mechanism 530 includes a steering mechanism unit 520 and an auxiliary mechanism unit 540. The electric power steering device 1000 controls the auxiliary mechanism unit 540 by the control device 100 to generate an auxiliary torque that assists a steering torque Tₕ generated in the steering mechanism unit 520 when a driver who drives the vehicle V steers a steering wheel 521. The auxiliary torque reduces the burden of the driver's operation when the driver operates the steering wheel 521. A driver of the vehicle V is a steering operator who steers the steering wheel 521 of the vehicle V.

The steering mechanism unit 520 includes the steering wheel 521, a steering shaft 522, universal joints 523A and 523B, an input shaft 524a, an output shaft 524b, a rack and pinion mechanism 525, a rack shaft 526, right and left ball joints 552A and 552B, tie rods 527A and 527B, knuckles 528A and 528B, and right and left tires 529A and 529B. That is, the steering mechanism 530 includes the steering wheel 521, the steering shaft 522, the universal joints 523A and 523B, the input shaft 524a, the output shaft 524b, the rack and pinion mechanism 525, the rack shaft 526, the right and left ball joints 552A and 552B, the tie rods 527A and 527B, the knuckles 528A and 528B, and the right and left tires 529A and 529B.

The steering shaft 522 is a shaft extending from the steering wheel 521 steered by a steering operator. One end portion of the input shaft 524a is connected to an end portion of the steering shaft 522 on a side opposite to a side connected to the steering wheel 521 via the universal joints 523A and 523B. As a result, the steering wheel 521 is connected to the input shaft 524a via the universal joints 523A and 523B and the steering shaft 522. The output shaft 524b is connected to the input shaft 524a via a torsion bar 546 described later. More specifically, one end portion of the output shaft 524b is connected to another end portion of the input shaft 524a via the torsion bar 546. The other end portion of the output shaft 524b is connected to the rack shaft 526 via the rack and pinion mechanism 525.

The input shaft 524a and the output shaft 524b are coaxially arranged. The input shaft 524a and the output shaft 524b are rotatable about the same central axis. The input shaft 524a and the output shaft 524b are relatively rotatable with respect to each other in a range in which the torsion bar 546 described later can be twisted.

The auxiliary mechanism unit 540 includes a steering torque sensor 541, a motor 543, a decelerator 544, an inverter 545, and the torsion bar 546. That is, the steering mechanism 530 includes the steering torque sensor 541, the motor 543, the decelerator 544, the inverter 545, and the torsion bar 546. The torsion bar 546 connects the input shaft 524a and the output shaft 524b. The torsion bar 546 is arranged coaxially with the input shaft 524a and the output shaft 524b. In the description below, a virtual axis passing through a common central axis of the input shaft 524a, the output shaft 524b, and the torsion bar 546 is referred to as a rotation axis R. The torsion bar 546 can be twisted around the rotation axis R.

The steering torque sensor 541 detects the steering torque Tₕ in the steering mechanism unit 520 by detecting the amount of torsion around the rotation axis R of the torsion bar 546. The steering torque Tₕ is a torsion bar torque generated in the torsion bar 546, and is torsional moment around the rotation axis R.

The rotation angle of the steering shaft 522 around the rotation axis R is detected by the steering angle sensor 542. The rotation angle of the steering shaft 522 around the rotation axis R is the steering angle θₕ of the steering wheel 521, and is equal to the rotation angle θₐ of the input shaft 524a. That is, the steering angle sensor 542 can detect the rotation angle θₐ of the input shaft 524a and the steering angle θₕ of the steering wheel 521 by detecting the rotation angle of the steering shaft 522. A rotation angle θ_{b} of the output shaft 524b can be detected based on the steering torque sensor 541 and the steering angle sensor 542. The rotation angle θ_{b} of the output shaft 524b is a steering angle θ₃. The detection result of the steering angle sensor 542 is transmitted to the control device 100 using, for example, a controller area network (CAN).

The inverter 545 converts DC power into three-phase AC power having U-phase, V-phase, and W-phase pseudo sine waves in accordance with a motor driving signal input from the control device 100, and supplies the power to the motor 543. The motor 543 is connected to the output shaft 524b via the decelerator 544. The three-phase AC power is supplied from the inverter 545 to the motor 543. The motor 543 is, for example, an interior permanent magnet synchronous motor (IPMSM), a surface mounted permanent magnet synchronous motor (SPMSM), a switched reluctance motor (SRM), or the like. When the three-phase AC power is supplied from the inverter 545, the motor 543 generates an auxiliary torque according to the steering torque Tₕ. The motor 543 transmits the generated auxiliary torque to the output shaft 524b via the decelerator 544.

The control device 100 is a control device that controls the steering mechanism 530 mounted on the vehicle V. In the present example embodiment, the control device 100 can control a first control target 560. The first control target 560 is a control target including the motor 543 provided in the steering mechanism 530. In the present example embodiment, the first control target 560 includes the steering mechanism unit 520, the torsion bar 546, the motor 543, and the decelerator 544. Since the first control target 560 includes the input shaft 524a and the output shaft 524b that can rotate relative to each other via the torsion bar 546, a motion of the first control target 560 cannot be described only by a simple equation of motion of a one-inertia system. The first control target 560 changes between a one-inertia system and a two-inertia system depending on the strength with which a steering operator grips the steering wheel 521. The stronger a steering operator grips the steering wheel 521, the closer the first control target 560 is to a one-inertia system. The weaker a steering operator grips the steering wheel 521, the closer the first control target 560 is to a two-inertia system. As described above, the first control target 560 includes a two-inertia system.

The control device 100 is electrically connected to the inverter 545. The control device 100 generates a motor driving signal based on detection signals detected by the steering torque sensor 541, the steering angle sensor 542, a vehicle speed sensor 300 mounted on the vehicle V, and the like and outputs the motor driving signal to the inverter 545. The control device 100 controls the first control target 560 by controlling rotation of the motor 543 via the inverter 545. More specifically, the control device 100 controls the switching operation of a plurality of switching elements included in the inverter 545. Specifically, the control device 100 generates a control signal for controlling the switching operation of each switching element and outputs the control signal to the inverter 545. Each switching element is, for example, a metal-oxide-semiconductor field-effect transistor (MOSFET). In the description below, a control signal for controlling the switching operation of each switching element is referred to as a “gate control signal”.

The control device 100 generates a torque command value based on the steering torque Tₕ and the like, and controls the torque of the motor 543 and the rotation speed of the motor 543 by means of, for example, vector control. The vector control is a method in which current flowing through the motor 543 is separated into a current component that contributes to generation of a torque and a current component that contributes to generation of a magnetic flux, and the current components orthogonal to each other are independently controlled. The control device 100 may perform not only the vector control but also another piece of closed-loop control. A rotational speed of the motor 543 is expressed by, for example, a rotational speed [revolutions per minute (rpm)] at which a rotor rotates in one minute, a rotational speed [revolutions per second (rps)] at which a rotor rotates in one second, or the like.

Note that a value of the steering torque Tₕ may be directly input to the control device 100 from the steering torque sensor 541, or the control device 100 may calculate a value of the steering torque Tₕ from an output value of the steering torque sensor 541. The steering angle sensor 542 may detect the rotation angle θₐ of the input shaft 524a. A value of the steering angle θₕ of the steering wheel 521 may be directly input to the control device 100 from the steering angle sensor 542, or the control device 100 may calculate a value of the steering angle θₕ from an output value of the steering angle sensor 542.

In the present example embodiment, the electric power steering device 1000 includes a motor device 100a. The motor device 100a includes the control device 100, the motor 543, and the inverter 545. The motor device 100a can be manufactured and sold independently of a portion other than the motor device 100a of the electric power steering device 1000. In addition, the control device 100 can be manufactured and sold as a control device for controlling the electric power steering device 1000 independently of a portion other than the control device 100 of the motor device 100a.

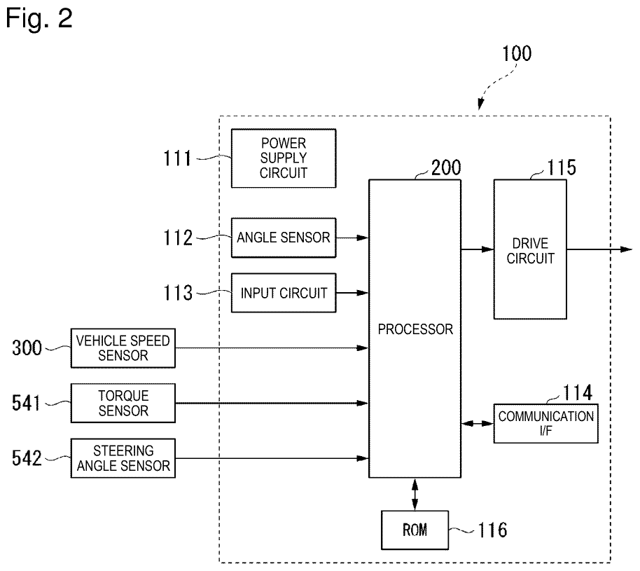

FIG. 2 illustrates a typical example of the configuration of the control device 100 according to the present example embodiment. The control device 100 includes a power supply circuit 111, an angle sensor 112, an input circuit 113, a communication I/F 114, a driving circuit 115, a ROM 116, and a processor 200, for example. The control device 100 may be realized as a printed circuit board (PCB) on which these electronic components are mounted.

The vehicle speed sensor 300, the steering torque sensor 541, and the steering angle sensor 542 mounted on the vehicle V are connected to the processor 200 so as to be able to input signals to the processor 200. The processor 200 receives the vehicle speed from the vehicle speed sensor 300. The processor 200 receives the steering torque Tₕ from the steering torque sensor 541. The processor 200 receives the steering angle θₕ from the steering angle sensor 542.

The processor 200 is a semiconductor integrated circuit, and is also referred to as a central processing unit (CPU) or a microprocessor. The processor 200 sequentially executes computer programs which are stored in the ROM 116 and describe commands for controlling motor driving, and realizes desired processing. In addition to the processor 200 or instead of the processor 200, the control device 100 may include a field programmable gate array (FPGA) equipped with a CPU, a graphics processing unit (GPU), an application specific integrated circuit (ASIC), an application specific standard product (ASSP), or a combination of two or more circuits selected from these circuits. The processor 200 sets a current command value according to the actual current value, the rotation angle of the rotor of the motor 543, and the like, generates a pulse width modulation (PWM) signal, and outputs the PWM signal to the driving circuit 115.

The power supply circuit 111 is connected to an external power supply (not illustrated). The power supply circuit 111 generates DC voltage necessary for each unit of the control device 100. The DC voltage generated in the power supply circuit 111 is, for example, 3 V or 5 V.

The angle sensor 112 detects a rotation angle θₘ of the rotor of the motor 543, and outputs the rotation angle θₘ to the processor 200. In the present example embodiment, the rotation angle θₘ is a “first output value” indicating the output of the motor 543. The angle sensor 112 may be a resolver, a Hall element such as a Hall IC, or an MR sensor having a magnetoresistive element. The processor 200 can calculate an angular velocity ω [rad/s] of the motor 543 based on an electrical angle of the motor 543 obtained based on the angle sensor 112. Note that the control device 100 may include, instead of the angle sensor 112, a speed sensor capable of detecting a rotational angular velocity of the motor 543 and an acceleration sensor capable of detecting a rotational angular acceleration of the motor 543.

A motor current value detected by a current sensor (not illustrated) is input to the input circuit 113. In the description below, a motor current value detected by a current sensor (not illustrated) is referred to as an “actual current value”. The input circuit 113 converts the level of an input actual current value into an input level of the processor 200 as necessary, and outputs the actual current value to the processor 200. A typical example of the input circuit 113 is an analog-digital conversion circuit.

The communication I/F 114 is an input and output interface for transmitting and receiving data in conformity with an in-vehicle controller area network (CAN), for example.

The driving circuit 115 is typically a gate driver or a pre-driver. The driving circuit 115 generates a gate control signal in accordance with a PWM signal, and gives the gate control signal to gates of a plurality of switching elements included in the inverter 545. For example, when the motor 543 to be driven is a motor that can be driven at a low voltage, the driving circuit 115 as a gate driver is not necessarily required in some cases. In that case, the function of the gate driver in the driving circuit 115 may be implemented in the processor 200.

The ROM 116 is electrically connected to the processor 200. The ROM 116 is a writable memory, a rewritable memory, or a read-only memory, for example. Examples of the writable memory include a programmable read only memory (PROM). Examples of the rewritable memory include a flash memory, an electrically erasable programmable read only memory (EEPROM), and the like. The ROM 116 stores therein a control program including commands for causing the processor 200 to control motor driving. For example, the control program stored in the ROM 116 is once developed in a RAM (not illustrated) at the time of booting.

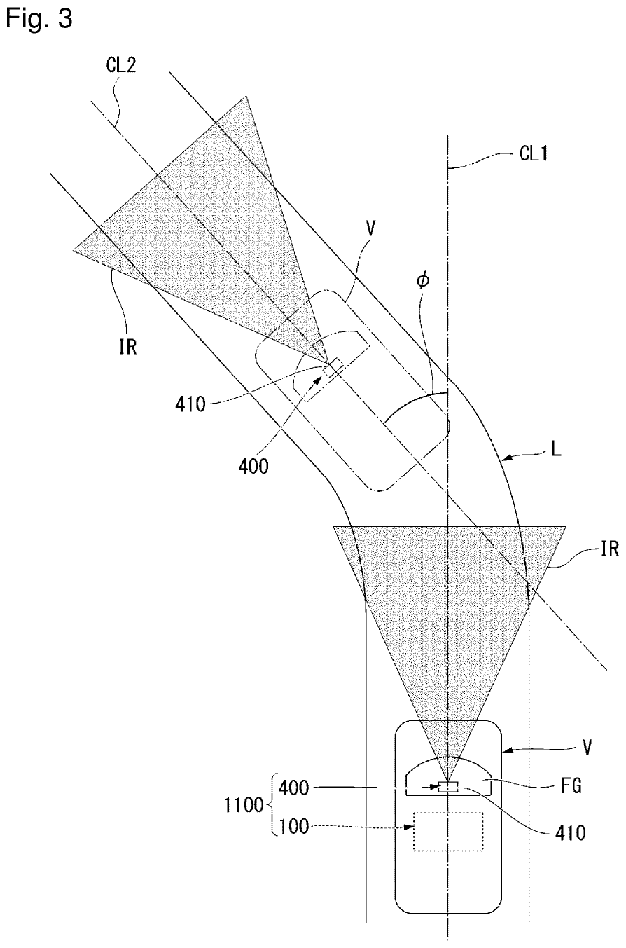

As illustrated in FIG. 3, a lane keeping system 1100 includes the control device 100 and an imaging device 400. The lane keeping system 1100 is a system for keeping the vehicle V driven by a person at the center of a lane L. When the vehicle V is about to deviate from the center of the lane L based on an image of the lane L captured by the imaging device 400, the lane keeping system 1100 controls the steering mechanism 530 by the control device 100 to return the vehicle V to a position at the center of the lane L. The imaging device 400 is attached to, for example, a windshield FG of the vehicle V.

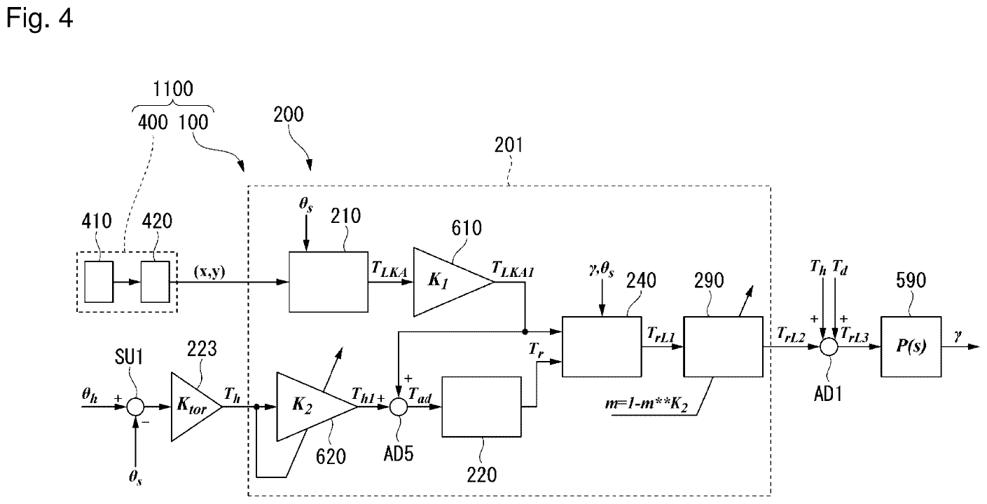

As illustrated in FIG. 4, the imaging device 400 includes an imaging device main body 410 and an imaging device controller 420. The imaging device main body 410 images a portion located in front of the vehicle V of the lane L. The imaging device main body 410 is, for example, a camera including a charge coupled device (CCD) image sensor. The imaging device controller 420 controls the imaging device main body 410. Similarly to the processor 200, the imaging device controller 420 is a semiconductor integrated circuit. The imaging device controller 420 outputs target coordinates x and y based on an image captured by the imaging device main body 410.

FIG. 4 illustrates an example of functional blocks of the processor 200 of the present example embodiment. The processor 200, which is a computer, sequentially executes processing or tasks necessary for controlling the steering mechanism 530 by using each functional block. Each functional block of the processor 200 illustrated in FIG. 4 may be implemented in the processor 200 as software such as firmware, may be implemented in the processor 200 as hardware, or may be implemented in the processor 200 as software and hardware. The processing of each functional block in the processor 200 is typically described in a computer program in units of software modules and stored in the ROM 116. However, in a case where an FPGA or the like is used, all or a part of the functional blocks may be implemented as a hardware accelerator. A method of controlling the first control target 560 according to the present example embodiment is executed by the processor 200, which is a computer, executing a program stored in the control device 100. That is, the program of the present example embodiment stored in the control device 100 causes the processor 200, which is a computer, to execute the method of controlling the first control target 560 of the present example embodiment. In the present example embodiment, the control device 100 also stores therein a program for causing the processor 200, which is a computer, to execute a method of controlling a second control target 580 to be described later.

The processor 200 includes a controller 201, a subtractor SU1, and a torque conversion unit 223. The controller 201 includes a first assist controller 210, a second assist controller 220, a vehicle stabilization controller 240, a disturbance sensitivity controller 290, a first gain adjustment unit 610, a second gain adjustment unit 620, and an adder AD5. That is, the control device 100 includes the first assist controller 210, the second assist controller 220, the vehicle stabilization controller 240, the disturbance sensitivity controller 290, the first gain adjustment unit 610, the second gain adjustment unit 620, and the adder AD5. In other words, functions corresponding to the first assist controller 210, the second assist controller 220, the vehicle stabilization controller 240, the disturbance sensitivity controller 290, the first gain adjustment unit 610, the second gain adjustment unit 620, and the adder AD5 are implemented in the processor 200 of the control device 100.

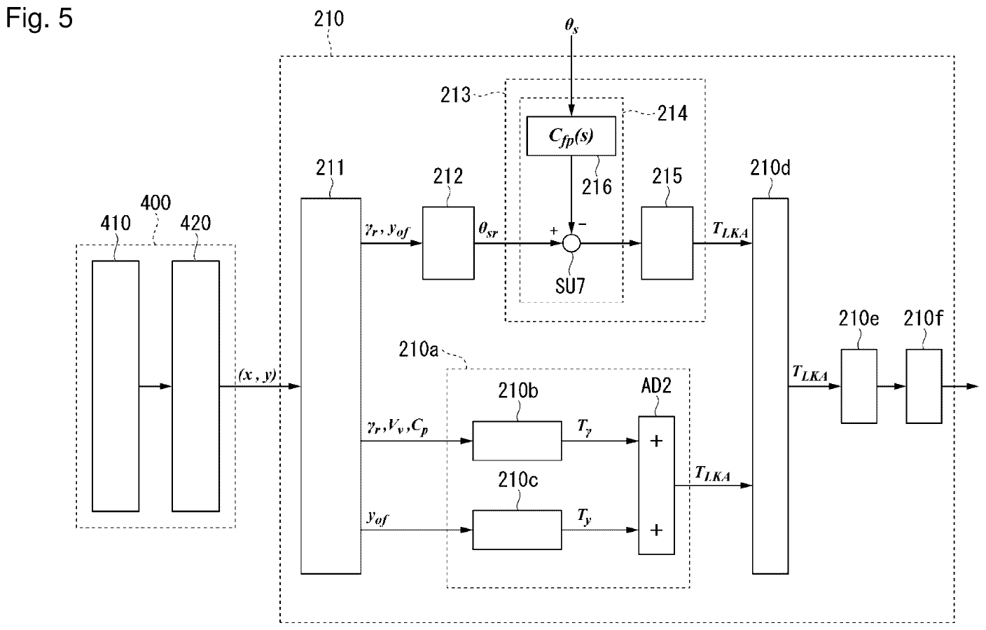

The first assist controller 210 can execute lane keeping control to keep the vehicle V in the lane L. As illustrated in FIG. 5, the first assist controller 210 includes a vehicle state calculator 211, a calculator 212, a first generator 213, a second generator 210a, a selection processing unit 210d, a vehicle characteristic compensator 210e, and a correction unit 210f. The vehicle state calculator 211 calculates a yaw rate target value γᵣ which is a target value of a yaw rate γ of the vehicle V and lateral displacement y_{of} the vehicle V, based on an input from the imaging device 400. The yaw rate target value γᵣ is a yaw rate γ required for the vehicle V not to deviate from the inside of the lane L.

The yaw rate γ of the vehicle V is a parameter indicating a change in a yaw angle φ which is a deflection angle in the left-right direction of the vehicle V. In other words, the yaw rate γ is an angular velocity when the vehicle V swings in the left-right direction. In the example illustrated in FIG. 3, in the lane L provided with a curve curving to the left, the vehicle V before turning the curve is indicated by a solid line, and the vehicle V after turning the curve is indicated by a two-dot chain line. An angle formed by an imaginary line CL1 extending in a traveling direction of the vehicle V indicated by a solid line and an imaginary line CL2 extending in a traveling direction of the vehicle V indicated by a two-dot chain line is the yaw angle φ that changes when the vehicle V turns the curve. Note that, for example, the imaginary lines CL1 and CL2 coincide with an optical axis of the imaging device main body 410 when viewed from the upper side in a vertical direction. The optical axis of the imaging device main body 410 passes through the center in the left-right direction of a region IR imaged by the imaging device main body 410.

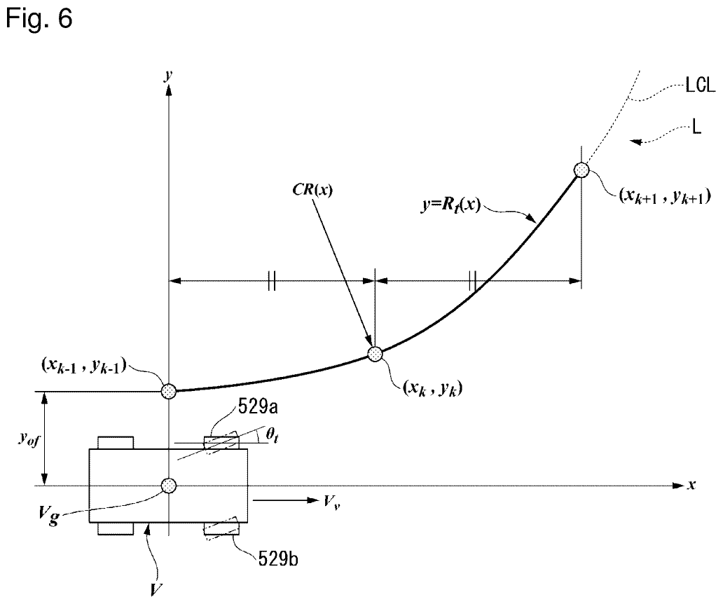

FIG. 6 illustrates an xy coordinate system. The x axis is an axis extending in one direction in the horizontal direction. The y axis is an axis extending in one direction in the horizontal direction and extending in a direction orthogonal to the x axis. FIG. 6 illustrates an example when the vehicle V traveling in the x-axis direction curves in the y-axis direction. In the vehicle V traveling in the x-axis direction, the lateral displacement y_{of} is a displacement amount of the position of the vehicle V in the y-axis direction with respect to a target route Rₜ(x). The target route Rₜ(x) is a target route through which the center of gravity V_{g} of the vehicle V passes, and is located on a center line LCL of the lane L. The position of the vehicle V in the xy coordinates illustrated in FIG. 6 is assumed to be the position of the center of gravity V_{g} of the vehicle V in the xy coordinates. That is, the lateral displacement y_{of} is a distance in the y-axis direction between the target route Rₜ(x) and the center of gravity V_{g}. Note that at a position of the vehicle V illustrated in FIG. 6, xy coordinates of the center of gravity V_{g} is (0, 0).

The vehicle state calculator 211 calculates the yaw rate target value γᵣ and the lateral displacement y_{of} based on the target coordinates x and y input from the imaging device 400. In the present example embodiment, values of three target coordinates (x, y) of coordinates (xₖ₋₁, yₖ₋₁), coordinates (xₖ, yₖ), and coordinates (xₖ₊₁, yₖ₊₁) are input from the imaging device 400 to the vehicle state calculator 211. The three target coordinates (x, y) are coordinates included in the target route Rₜ(x) on the target center line LCL. The coordinates (xₖ₋₁, yₖ₋₁) are coordinates on the target route Rₜ(x) at a current position of the vehicle V in the x-axis direction. The coordinates (xₖ₊₁, yₖ₊₁) are coordinates on the target route Rₜ(x) at a position in the x-axis direction ahead of the current position in the x-axis direction of the vehicle V. The coordinates (xₖ, yₖ) are coordinates on the target route Rₜ(x) at a position in the x-axis direction of the center between a position in the x-axis direction of the coordinates (xₖ₋₁, yₖ₋₁) and a position in the x-axis direction of the coordinates (xₖ₊₁, yₖ₊₁). The target route Rₜ(x) is a target position in the y-axis direction with respect to a position in the x-axis direction. The target route Rₜ(x) is expressed as, for example, Expression (1) below.

$$\begin{matrix}Expression 1 & \\ {R}_{t} ( x ) = \frac{{C}_{r p}}{6} {x}^{3} + \frac{{C}_{p}}{2} {x}^{2} + {y}_{o f} & ( 1 )\end{matrix}$$

Here, Cᵣₚ represents a change rate of a curvature of the target route Rₜ (x) at the coordinates (xₖ₊₁, yₖ₊₁), Cₚ represents a curvature of the target route Rₜ (x) at the coordinates (xₖ₊₁, yₖ₊₁), and y_{of} represents lateral displacement of the vehicle V.

The vehicle state calculator 211 substitutes values of the three coordinates (xₖ₋₁, yₖ₋₁), (xₖ, yₖ), and (xₖ₊₁, yₖ₊₁) into Expression (2) below to calculate a value of each term in Expression (1). As a result, the lateral displacement y_{of} is calculated.

$$\begin{matrix}Expression 2 & \\ ( \begin{matrix}\frac{Crp}{6} \\ \frac{Cp}{2} \\ {y}_{of}\end{matrix} ) = {( \begin{matrix}{x}_{k - 1}^{3} & {x}_{k - 1}^{2} & 1 \\ {x}_{k}^{3} & {x}_{k}^{2} & 1 \\ {x}_{k + 1}^{3} & {x}_{k + 1}^{2} & 1\end{matrix} )}^{- 1} ( \begin{matrix}{y}_{k - 1} \\ {y}_{k} \\ {y}_{k + 1}\end{matrix} ) & ( 2 )\end{matrix}$$

The vehicle state calculator 211 substitutes the change rate Cᵣₚ, the curvature Cₚ, and the coordinates xₖ₋₁, xₖ₊₁ calculated from Expression (2) above into Expression (3) below to calculate a curvature radius R_{c}(xₖ₋₁) of the target route Rₜ(x) at the coordinates (xₖ₋₁, yₖ₋₁).

$$\begin{matrix}Expression 3 & \\ {R}_{c} ( {x}_{k - 1} ) = \frac{1}{{C}_{r p} \times ( {x}_{k - 1} - {x}_{k + 1} ) + {C}_{p}} & ( 3 )\end{matrix}$$

The vehicle state calculator 211 substitutes the curvature radius Rₑ(xₖ₋₁) obtained based on Expression (3) above into Expression (4) below to calculate the yaw rate target value yr.

$$\begin{matrix}Expression 4 & \\ {γ}_{r} = \frac{{V}_{v}}{{R}_{c} ( {x}_{k - 1} )} & ( 4 )\end{matrix}$$

Here, V₂ represents a traveling speed of the vehicle V.

As described above, the vehicle state calculator 211 calculates the yaw rate target value yr and the lateral displacement y_{of}. As illustrated in FIG. 5, the yaw rate target value γᵣ and the lateral displacement yr calculated by the vehicle state calculator 211 are input to the calculator 212 and the second generator 210a.

The calculator 212 calculates the target steering angle θₛᵣ based on the input yaw rate target value γᵣ and the lateral displacement y_{of}. The target steering angle θₛᵣ is a steering angle θₛ necessary for setting the yaw rate γ to the yaw rate target value γᵣ and converging the lateral displacement y_{of} to zero, and is a steering angle θₛ necessary for preventing the vehicle V from deviating from the lane L. In the present example embodiment, the target steering angle θₛᵣ is a target value of the output of the decelerator 544. The target steering angle θₛᵣ calculated by the calculator 212 is input to the first generator 213. More specifically, the target steering angle θₛᵣ is input to a subtractor SU7 described later of the first generator 213.

The first generator 213 generates a first command torque T_{LKA} based on the target value of the output of the decelerator 544, that is, the target steering angle θₛᵣ. In the present example embodiment, the first command torque T_{LKA} is a “first input value” generated by the first assist controller 210. The steering angle θₛ is fed back to the first generator 213. In the present example embodiment, the steering angle θₛ is a “second output value” indicating the output of the decelerator 544. The first generator 213 generates the first command torque T_{LKA} by, for example, proportional-differential (PD) control. The first generator 213 includes a compensator 214 and a torque calculator 215.

The steering angle θₛ fed back to the first generator 213 is input to the compensator 214. The compensator 214 performs phase delay compensation processing on a phase delay generated in the steering angle θ, fed back. The compensator 214 includes a phase delay element 216 and the subtractor SU7. The phase delay element 216 is a phase delay element that delays the phase of the steering angle θₛ fed back to the first generator 213. The steering angle θₛ is input to the phase delay element 216. A transfer function θ_{fp}(s) of the phase delay element 216 is expressed by, for example, Expression (5) below.

$$\begin{matrix}Expression 5 & \\ {C}_{fp} ( s ) = \frac{{τ}_{p z} s + 1}{{τ}_{p p} s + 1} & ( 5 )\end{matrix}$$

Here, s represents a Laplace transducer, and τ_{pz} and τₚₚ represent time constants.

The output from the phase delay element 216 is input to the subtractor SU7. The subtractor SU7 subtracts the output of the phase delay element 216 from the target steering angle θₛᵣ and outputs the result to the torque calculator 215. The torque calculator 215 calculates the first command torque T_{LKA} based on the target steering angle θₛᵣ input from the subtractor SU7. The first command torque T_{LKA} is a torque necessary for setting the steering angle θₛ to the target steering angle θₛᵣ. In the present example embodiment, the torque calculator 215 calculates the first command torque T_{LKA} by adding a value obtained by multiplying the target steering angle θₛᵣ by a proportional gain K_{P} in the proportional control (P control) and a value obtained by multiplying the differentiated target steering angle θₛᵣ by a differential gain K_{D} in the differential control (D control). The first command torque T_{LKA} calculated by the torque calculator 215 is input to the selection processing unit 210d.

In the compensator 214, the phase of the steering angle θₛ can be advanced by subtracting the steering angle θₛ whose phase is delayed by the phase delay element 216 from the target steering angle θₛᵣ by the subtractor SU7, and the phase delay generated in the steering angle θₛ can be compensated. This is because by inverting the phase delay caused by the phase delay element 216 by subtraction by the subtractor SU7, the effect of phase advance can be obtained as a result.

The first command torque T_{LKA} is expressed by, for example, Expression (6) below. When the disturbance is ignored, the steering angle θₛ is simply expressed by Expression (7) below.

$$\begin{matrix}Expression 6 & \\ {T}_{L K A} ( s ) = {K}_{P} \{ {θ}_{sr} ( s ) - {C}_{f p} ( s ) {θ}_{s} ( s ) \} & ( 6 )\end{matrix}$$

Here, K_{P} represents a proportional gain in the torque calculator 215, C_{fp}(s) represents a transfer function of the phase delay element 216, θₛᵣ(s) represents a target steering angle, and θₛ(s) represents a steering angle.

$$\begin{matrix}Expression 7 & \\ {θ}_{s} ( s ) = {C}_{L} ( s ) {P}_{m} ( s ) \{ {C}_{EPS} ( s ) {T}_{h} + {T}_{L K A} ( s ) \} & ( 7 )\end{matrix}$$

Here, C_{L}(s) represents a response delay element of the output of the decelerator 544 with respect to the output of the motor 543, Pₘ(s) represents a transfer function of the motor 543, C_{EPS}(s) represents a transfer function of the second assist controller 220, Tₕ represents the steering torque, and T_{LKA} represents the first command torque.

When the steering torque Tₕ is set to zero on the assumption that no force is applied to the steering wheel 521, the transfer function θₛ/θₛᵣ from the target steering angle θₛᵣ to the steering angle θₛ is expressed by Expression (8) below, from Expressions (6) and (7) above.

$$\begin{matrix}Expression 8 & \\ \frac{{θ}_{s} ( s )}{{θ}_{s r} ( s )} = \frac{{K}_{P} {C}_{L} ( s ) {P}_{m} ( s )}{1 + {K}_{P} {C}_{L} ( s ) {P}_{m} ( s ) {C}_{f p} ( s )} & ( 8 )\end{matrix}$$

From Expression (8) above, it is found that the effect of phase advance is obtained in the transfer function θₛ/θₛᵣ from the target steering angle θₛᵣ to the steering angle θₛ by using the transfer function C_{fp}(s) of the phase delay element 216 as the phase delay element. Note that, since K_{P}C_{L}(s)Pₘ(s) in Expression (8) above is a delay element, it can be approximated by, for example, a first-order phase delay element. It is confirmed that the effect of phase advance is obtained by approximating K_{P}C_{L}(s)Pₘ(s) by a first-order phase delay element and confirming the responsiveness of the expression obtained by substituting the above-described Expression (5) into the transfer function C_{fp}(s) by a Bode diagram.

The second generator 210a generates the first command torque T_{LKA} based on an output from the vehicle state calculator 211. The second generator 210a includes a yaw rate controller 210b, a lateral displacement controller 210c, and an adder AD2. The yaw rate target value γᵣ, the traveling speed Vᵥ of the vehicle V, and the curvature Cₚ of the target route Rₜ(x) at the coordinates (xₖ₊₁, yₖ₊₁) are input to the yaw rate controller 210b. The yaw rate controller 210b generates a yaw rate command torque T_{γ} based on these input values. The lateral displacement y_{of} is input to the lateral displacement controller 210c. The lateral displacement controller 210c generates a lateral displacement command torque T_{y} based on the lateral displacement y_{of}. The yaw rate command torque T_{γ} output from the yaw rate controller 210b and the lateral displacement command torque T_{y} output from the lateral displacement controller 210c are added together in the adder AD2 and output as the first command torque T_{LKA}. The first command torque T_{LKA} generated by the second generator 210a is input to the selection processing unit 210d.

The selection processing unit 210d receives the first command torque T_{LKA} from each of the first generator 213 and the second generator 210a. The selection processing unit 210d performs processing of selecting which first command torque T_{LKA} of the first command torque T_{LKA} input from the first generator 213 and the first command torque T_{LKA} input from the second generator 210a is to be adopted. For example, the selection processing unit 210d adopts the first command torque T_{LKA} input from the first generator 213 in the case where the target steering angle θₛᵣ can be generated in the calculator 212, and adopts the first command torque T_{LKA} input from the second generator 210a in other cases. The selection processing unit 210d outputs the adopted first command torque T_{LKA} to the vehicle characteristic compensator 210e.

The vehicle characteristic compensator 210e is a part that compensates for a vehicle characteristic based on the relationship between the steering angle θₕ and the yaw rate γ indicating the change in the yaw angle φ of the vehicle V on which the steering mechanism 530 is mounted. The vehicle characteristic is a transmission characteristic when the steering angle θₕ is input and the yaw rate γ is output. The transfer function of the vehicle characteristic compensator 210e is, for example, a transfer function that can cancel the vehicle characteristic. The first command torque T_{LKA} compensated for the vehicle characteristic by the vehicle characteristic compensator 210e is input to the correction unit 210f. The correction unit 210f is a unit that performs correction in consideration of the mechanical characteristics of the arm of the steering operator. The correction unit 210f corrects the first command torque T_{LKA} output from the vehicle characteristic compensator 210e. The first command torque T_{LKA} corrected by the correction unit 210f is output from the first assist controller 210.

The target steering angle θₛᵣ input to the first generator 213 may be a value input to the control device 100 from the outside of the control device 100. The target steering angle θₛᵣ may be input from the imaging device 400 to the first generator 213, for example. When the target steering angle θₛᵣ is input to the first generator 213 from the outside of the control device 100, the first generator 213 may select whether to generate the first command torque T_{LKA} based on the target steering angle θₛᵣ input from the outside of the control device 100 or generate the first command torque T_{LKA} based on the target steering angle θₛᵣ calculated by the calculator 212. When the target steering angle θₛᵣ is input to the first generator 213 from the outside of the control device 100, the first generator 213 may generate the first command torque T_{LKA} based on an average value of the target steering angle θₛᵣ input from the outside of the control device 100 and the target steering angle θₛᵣ calculated by the calculator 212. When the target steering angle θₛᵣ is input to the first generator 213 from the outside of the control device 100, the calculator 212 may not be provided and the target steering angle θₛᵣ may not be generated in the first assist controller 210. For example, when the target steering angle θₛᵣ is input to the first generator 213 from the outside of the control device 100, the selection processing unit 210d adopts the first command torque T_{LKA} input from the first generator 213.

As illustrated in FIG. 4, the first command torque T_{LKA} output from the first assist controller 210 is input to the first gain adjustment unit 610. The first gain adjustment unit 610 adjusts a gain of the first command torque T_{LKA}. The first gain adjustment unit 610 multiplies the first command torque T_{LKA} by a first gain K₁ and outputs the obtained value as a first command torque T_{LKA1}. The first gain K₁ is a variable value. The first gain K₁ is expressed by K₁=1−K₂ by using a second gain K₂ of the second gain adjustment unit 620. The first command torque T_{LKA1} is input to the adder AD5 and the vehicle stabilization controller 240.

The steering angle θₕ detected based on the steering angle sensor 542 is input to the subtractor SU1. The subtractor SU1 subtracts the steering angle θₛ detected based on the steering torque sensor 541 and the steering angle sensor 542 from the steering angle θₕ, and outputs the obtained value to the torque conversion unit 223.

The value output from the subtractor SU1 is input to the torque conversion unit 223. The torque conversion unit 223 multiplies the value output from the subtractor SU1 by a gain and outputs the steering torque Tₕ. The gain in the torque conversion unit 223 is equal to a spring constant Kₜₒᵣ of the torsion bar 546. A value obtained by multiplying a difference between the steering angle θₕ and the steering angle θₛ by the spring constant Kₜₒᵣ of the torsion bar 546 is a torsion bar torque, that is, the steering torque Tₕ. The steering torque Tₕ is input to the second gain adjustment unit 620.

The second gain adjustment unit 620 adjusts the gain of the steering torque Tₕ. The second gain adjustment unit 620 multiplies the steering torque Tₕ by the second gain K₂ and outputs the obtained value as a steering torque Tₕ₁. The second gain K₂ is 0 or more and 1 or less. The second gain K₂ is a variable value that changes depending on the value of the steering torque Tₕ. From a relationship of K₁=1−K₂ described above, the first gain K₁ is zero when the second gain K₂ is 1, the first gain K₁ is 0.5 when the second gain K₂ is 0.5, and the first gain K₁ is 1 when the second gain K₂ is zero. The larger the value of the second gain K₂, the greater the influence of the steering torque Tₕ input by a steering operator via the steering wheel 521, and the larger the value of the first gain K₁, the greater the influence of the first command torque T_{LKA} output from the first assist controller 210. The first gain K₁ in a case where the first assist controller 210 executes lane keeping control is larger than the first gain K₁ in a case where the first assist controller 210 does not execute the lane keeping control. The steering torque Tₕ₁ output from the second gain adjustment unit 620 is input to the adder AD5. The adder AD5 adds the first command torque T_{LKA1} to the steering torque Tₕ₁ and outputs the obtained value to the second assist controller 220.

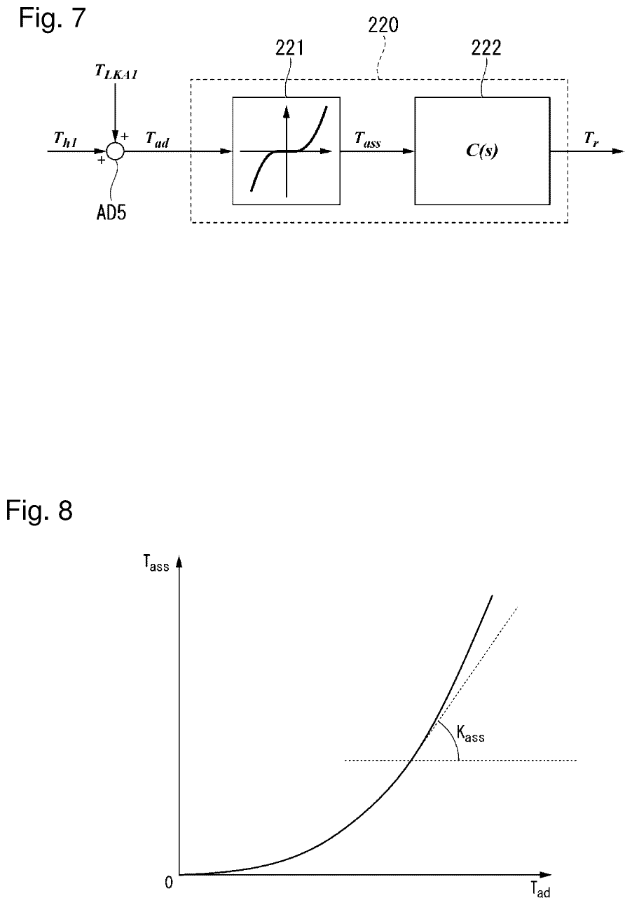

The second assist controller 220 generates a second command torque Tᵣ input to the vehicle stabilization controller 240 based on a steering input value input from the steering wheel 521 of the vehicle V. In the present example embodiment, the steering input value is the steering torque Tₕ. In the present example embodiment, the second command torque Tᵣ is a “second input value” generated by the second assist controller 220. The second assist controller 220 generates the second command torque Tᵣ and controls the torque of the motor 543 to control reaction force transmitted from the steering wheel 521 to a steering operator. As illustrated in FIG. 7, the second assist controller 220 includes a base assist controller 221 and a phase compensator 222.

The base assist controller 221 generates an assist torque Tₐₛₛ for compensating at least a part of a self-aligning torque T_{SAT} generated in the tires 529A and 529B of the vehicle based on the torsion bar torque generated in the torsion bar 546, that is, the input torque T_{ad} calculated based on the steering torque Tₕ. In the present example embodiment, the base assist controller 221 generates the assist torque Tₐₛₛ based on the input torque T_{ad} calculated by adding the steering torque Tₕ₁ obtained by multiplying the steering torque Tₕ by the second gain K₂ and the first command torque T_{LKA1} obtained by multiplying the first command torque T_{LKA} by the first gain K₁.

In the present example embodiment, the base assist controller 221 outputs the assist torque Tₐₛₛ by multiplying the input torque T_{ad} by an assist gain Kₐₛₛ. FIG. 8 illustrates an example of a relationship between the input torque T_{ad} and the assist torque Tₐₛₛ. In the graph of FIG. 8, the horizontal axis indicates the input torque T_{ad}, the vertical axis indicates the assist torque Tₐₛₛ, and an inclination of the assist torque Tₐₛₛ with respect to the input torque T_{ad} is the assist gain Kₐₛₛ. The input torque T_{ad}, the assist torque Tₐₛₛ, and the assist gain Kₐₛₛ satisfy a relationship of dTₐₛₛ/dT_{ad}=Kₐₛₛ. As illustrated in FIG. 8, the assist torque Tₐₛₛ increases exponentially as the input torque T_{ad} increases, for example. As illustrated in FIG. 7, the assist torque Tₐₛₛ output from the base assist controller 221 is input to the phase compensator 222.

Note that the base assist controller 221 may generate the assist torque Tₐₛₛ based on the input torque T_{ad} and the traveling speed Vᵥ of the vehicle V. The base assist controller 221 may include, for example, a lookup table (LUT) in which a relationship between the input torque T_{ad}, the traveling speed V₂, and the assist torque Tₐₛₛ is defined, and determine the assist torque Tₐₛₛ with reference to the lookup table.

The phase compensator 222 in the present example embodiment adjusts a gain within a range that a steering frequency can take when a steering operator operates the steering wheel 521, and compensates for rigidity of the torsion bar 546. The range that a steering frequency can take is, for example, 5 Hz or less. The phase compensator 222 may apply, for example, first-order phase compensation to the assist torque Tₐₛₛ when the steering frequency is 5 Hz or less. The first-order phase compensation is expressed by, for example, a transfer function C(s) of Expression (9).

$$\begin{matrix}Expression 9 & \\ C ( s ) = \frac{\frac{1}{2 π {f}_{3}} s + 1}{\frac{1}{2 π {f}_{4}} s + 1} & ( 9 )\end{matrix}$$

Here, s represents a Laplace transformer, f₃ represents a frequency [Hz] of a zero point of the transfer function C(s), and f₄ represents a frequency [Hz] of a pole of the transfer function C(s).

The phase compensator 222 generates the second command torque Tᵣ based on the assist torque Tₐₛₛ output from the base assist controller 221 and a gain of the phase compensator 222. That is, the second command torque Tᵣ, which is a second input value, is calculated based on the assist torque Tₐₛₛ. For example, the phase compensator 222 is a stabilization compensator and can apply stability phase compensation to the assist torque Tₐₛₛ. The phase compensator 222 may have a second-order or higher transfer function whose frequency characteristic is variable according to the gain of the transfer function C(s). The second-order or higher transfer function is expressed using a responsiveness parameter and a damping parameter. The second-order or higher transfer function C(s) can be expressed by, for example, Expression (10). By setting the order number of the transfer function C(s) to the second order, damping can be given to the characteristic of the transfer function C(s). A phase characteristic can be adjusted by changing the damping.

$$\begin{matrix}Expression 10 & \\ C ( s ) = \frac{{s}^{2} + 2 {ζ}_{3} {ω}_{3} s + {ω}_{3}^{2}}{{s}^{2} + 2 {ζ}_{4} {ω}_{4} s + {ω}_{4}^{2}} ( \frac{{ω}_{4}^{2}}{{ω}_{3}^{2}} ) & ( 10 )\end{matrix}$$

In Expression (10), s represents a Laplace transformer, ω₃ represents a frequency of a zero point of the transfer function C(s), Ω₄ represents a frequency of a pole of the transfer function C(s), δ₃ represents a damping ratio of the zero point, and δ₄ represents a damping ratio of the pole. The frequency ω₄ of a pole is lower than the frequency ω₃ of a zero point.

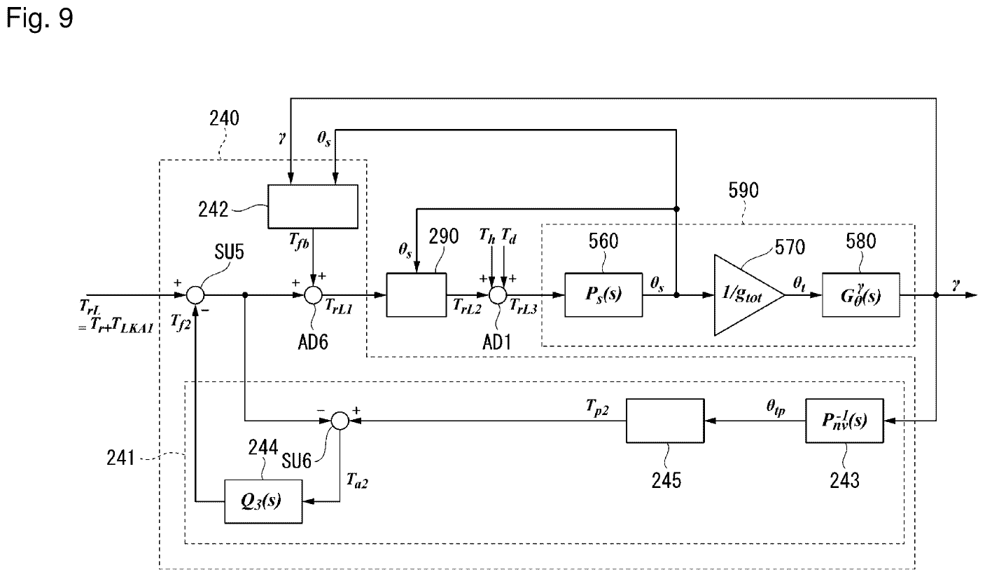

As illustrated in FIG. 4, the first command torque T_{LKA1} output from the first gain adjustment unit 610 and the second command torque Tᵣ output from the second assist controller 220 are input to the vehicle stabilization controller 240. As illustrated in FIG. 9, the vehicle stabilization controller 240 includes a second model following controller 241, a second state feedback loop 242, a subtractor SU5, and an adder AD6.

The subtractor SU5 receives a command torque T_{rL} obtained by adding the first command torque T_{LKA1} and the second command torque Tᵣ. The subtractor SU5 subtracts a second correction torque T_{f2} output from the second model following controller 241 from the input command torque T_{rL}. An output from the subtractor SU5 is input to the adder AD6 and the second model following controller 241. The adder AD6 outputs a command torque T_{rL1}, which is a value obtained by adding an output from the second state feedback loop 242 to the output from the subtractor SU5, to the disturbance sensitivity controller 290. In the present example embodiment, the command torque T_{rL1} is a “command value” calculated based on the first command torque T_{LKA1} multiplied by the first gain K₁ and the second command torque Tᵣ multiplied by the second gain K₂.

In the present example embodiment, the second model following controller 241 is a controller configured to perform model following control. The second model following controller 241 generates the second correction torque T_{f2} to correct the command torque T_{rL} based on the yaw rate γ and a second nominal model NM2. In the present example embodiment, the second correction torque T_{f2} is a feedback torque fed back to the command torque T_{rL}. The second nominal model NM2 is an internal model used as a model that constrains the second control target 580 when the second control target 580 is controlled. In the present example embodiment, the second control target 580 is a plant model that receives input of an actual steering angle θₜ of the tires 529A and 529B and outputs the yaw rate γ. As illustrated in FIG. 6, the actual steering angle θₜ is an angle at which the tires 529A and 529B are inclined in the left-right direction of the vehicle body of the vehicle V with respect to the front-rear direction of the vehicle body when viewed in the vertical direction. The second control target 580 illustrated in FIG. 9 is the vehicle V. A transfer function G_{θ}^{γ}(s) of the second control target 580 is determined by the characteristic of the vehicle V.

In the present example embodiment, the second model following controller 241 generates the second correction torque T_{f2} based on the yaw rate γ and feeds back the second correction torque T_{f2} to the command torque T_{rL}. The second model following controller 241 includes a second inverse nominal model 243, a filter 244, a torque conversion unit 245, and a subtractor SU6.

The second model following controller 241 is configured such that a transfer function of the second control target 580 is constrained to a transfer function Pₙᵥ(s) of the second nominal model NM2 in a frequency band in which a gain in the gain characteristic of a complementary sensitivity function with respect to a modeling error between the second control target 580 as a plant model and the second nominal model NM2 is substantially 1.

In the present description, “a transfer function of a certain control target is constrained to a transfer function of a certain nominal model” means that, for example, a control target is controlled such that a transfer function of the certain control target appears to be a transfer function of the certain nominal model apparently when an input and output relationship is viewed. Further, in the present description, “a certain gain is substantially 1” includes, for example, a case where the certain gain is 0.8 or more and 1.2 or less, in addition to a case where the certain gain is 1. The numerical range is, for example, a range in which a gain of a substantial disturbance reduction characteristic can be adjusted to 1 in consideration of positive efficiency and reverse efficiency of a worm gear in a case where the decelerator 544 connected to the motor 543 includes the worm gear. Since efficiency of the worm gear is about 0.8, it is necessary to adjust the gain by ±0.2 with respect to the target value 1.

A complementary sensitivity function with respect to a modeling error between the second control target 580 and the second nominal model NM2 is a complementary sensitivity function of an inner loop including the second model following controller 241. In the present example embodiment, the complementary sensitivity function in the second model following controller 241 is equal to a transfer function Q₃(s) of the filter 244. The transfer function Q₃(s), which is a complementary sensitivity function, has a gain of substantially 0 dB in a frequency band that the filter 244 allows to pass through, that is, a gain in a transfer function is substantially 1, for example. That is, in the present example embodiment, the second model following controller 241 is configured such that the transfer function G_{θ}^{γ}(s) of the second control target 580 is constrained to the transfer function Pₙᵥ(s) of the second nominal model NM2 in a frequency band in which a gain in the gain characteristic of the transfer function Q₃(s) is substantially 1. As described above, the vehicle stabilization controller 240 constrains the transfer function G_{θ}^{γ}(s) of the second control target 580, which is the plant model, to the predetermined transfer function Pₙᵥ(s) of the second nominal model NM2 by model following control performed by the second model following controller 241.

The second inverse nominal model 243 is an inverse model of the second nominal model NM2 used to constrain the second control target 580. The transfer function Pₙᵥ(s) of the second nominal model NM2 is expressed by, for example, Expression (11) below. A transfer function Pₙᵥ⁻¹(s) of the second inverse nominal model 243 is expressed by Expression (12) below.

$$\begin{matrix}Expression 11 & \\ {P}_{n v} ( s ) = \frac{{G}_{θ}^{γ} ( 0 )}{\frac{1}{2 π {f}_{n}} s + 1} & ( 11 )\end{matrix}$$

$$\begin{matrix}Expression 12 & \\ {P}_{n v}^{- 1} ( s ) = \frac{1}{{G}_{θ}^{γ} ( 0 )} ( \frac{1}{2 π {f}_{n}} s + 1 ) & ( 12 )\end{matrix}$$

where, s represents a Laplace transformer, fₙ represents a parameter corresponding to the natural frequency f_{γ} of the yaw rate γ, and G_{θ}^{γ}(0) represents a stationary gain of a transfer function from the actual steering angle θₜ of the tires 529A and 529B of the vehicle V to the yaw rate γ.

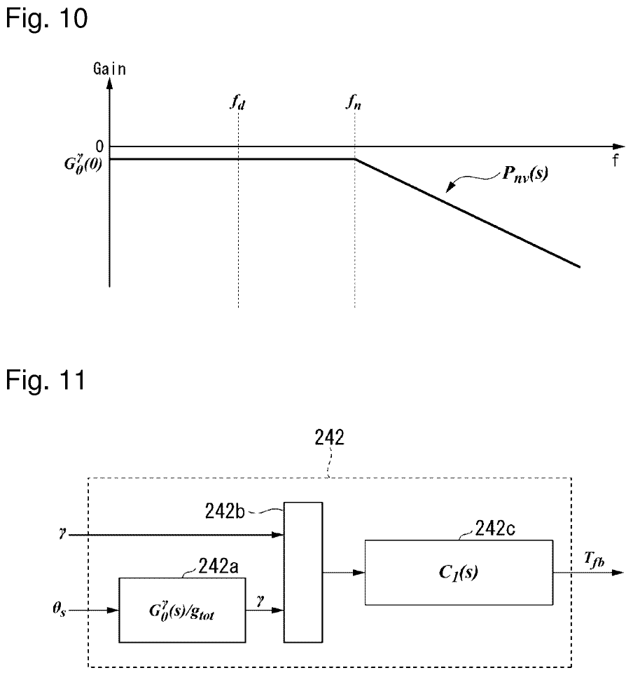

A gain in the transfer function Pₙᵥ(s) of the second nominal model NM2 is expressed, for example, as illustrated in FIG. 10. As illustrated in FIG. 10, a gain in the transfer function Pₙᵥ(s) of the second nominal model NM2 becomes the stationary gain G_{θ}^{γ}(0) in a frequency band equal to or less than the parameter fₙ corresponding to the natural frequency f_{γ} of the yaw rate γ, and decreases in a frequency band higher than the parameter fₙ. For example, by reducing the gain in the frequency band equal to or higher than the predetermined frequency f_{d} in the yaw rate target value γᵣ in the first assist controller 210, the second control target 580 can be controlled in the region where the gain in the transfer function Pₙᵥ(s) of the second nominal model NM2 becomes the stationary gain G_{θ}^{γ}(0). The predetermined frequency f_{d} is lower than the parameter fₙ set by model following control in the vehicle stabilization controller 240.

An output of the second control target 580, that is, the yaw rate γ is input to the second inverse nominal model 243. The second inverse nominal model 243 outputs the steering angle θₜₚ based on Expression (12) above and the input yaw rate γ. The steering angle θₜₚ is equal to the value of the actual steering angle θₜ input to the second nominal model NM2 in a case where an output value of the second nominal model NM2 is the same value as an output value of the second control target 580. The steering angle θₜₚ is input to the torque conversion unit 245. The torque conversion unit 245 converts the steering angle θₜₚ into a torque Tₚ₂ and outputs the torque Tₚ₂.

The subtractor SU6 subtracts the output of the subtractor SU5 from the output of the torque conversion unit 245 to generate a differential torque Tₐ₂. The differential torque Tₐ₂ output from the subtractor SU6 is input to the filter 244. The filter 244 performs filter processing on the differential torque Tₐ₂ to obtain the second correction torque T_{f2}, and outputs the second correction torque T_{f2} to the subtractor SU5.

The second model following controller 241 constrains the second control target 580 to the second nominal model NM2, so that the natural frequency f_{γ} of the yaw rate γ can be constrained to the parameter fₙ in the transfer function Pₙᵥ(s) of the second nominal model NM2.

The second state feedback loop 242 outputs a state feedback torque T_{fb} for approximating the characteristic of the vehicle V to a transfer function with a primary delay based on the yaw rate γ or the steering angle θₛ of the vehicle V. As illustrated in FIG. 11, the second state feedback loop 242 includes a yaw rate conversion unit 242a, a switch unit 242b, and a torque conversion unit 242c. The switch unit 242b switches which one of the yaw rate γ and the steering angle θₛ of the vehicle V is used to calculate the state feedback torque T_{fb}. In a case where there is a signal from the imaging device 400, the switch unit 242b outputs the yaw rate γ calculated based on the imaging device 400 to the torque conversion unit 242c. In a case where there is no signal from the imaging device 400, the switch unit 242b outputs the yaw rate γ calculated based on the steering angle θₛ to the torque conversion unit 242c. The yaw rate conversion unit 242a converts the input steering angle θₛ into the yaw rate γ and outputs the yaw rate γ to the switch unit 242b. A transfer function of the yaw rate conversion unit 242a is expressed by G_{θ}^{γ}(s)/gₜₒₜ. G_{θ}^{γ}(s) is a transfer characteristic from the actual steering angle θₜ to the yaw rate γ, and is a transfer function of the second control target 580. The conversion gain 1/gₜₒₜ is a conversion gain from the steering angle θₛ to the actual steering angle θₜ. The parameter gₜₒₜ is a parameter corresponding to a gear ratio from the steering angle θₛ to the actual steering angle θₜ.

The torque conversion unit 242c converts the yaw rate γ input from the switch unit 242b into the state feedback torque T_{fb} and outputs the state feedback torque T_{fb}. A transfer function C₁ (s) of the torque conversion unit 242c is expressed by Expression (13) below.

$$\begin{matrix}Expression 13 & \\ {C}_{1} ( s ) = \frac{1}{{G}_{θ}^{γ} ( 0 )} \frac{{τ}_{n} {K}_{d} s}{{C}_{r} {V}_{v} s + 1} & ( 13 )\end{matrix}$$

Here, s represents a Laplace transformer, and G_{θ}^{γ}(0), Cᵣ, and τₙ represent constant values determined by specifications of the vehicle V. G_{θ}^{γ}(0), Cᵣ, and τₙ are determined based on, for example, the traveling speed Vᵥ, a wheelbase, cornering forces of the tires 529A and 529B, yaw moment of the vehicle V, and the like. G_{θ}^{γ}(0) represents a stationary gain of a transfer function from the actual steering angle θₜ of the tires 529A and 529B of the vehicle V to the yaw rate γ.

As illustrated in FIG. 9, the state feedback torque T_{fb} output from the second state feedback loop 242 is input to the adder AD6 and added to the output from the subtractor SU5. The adder AD6 adds the state feedback torque T_{fb} to the output from the subtractor SU5 to obtain the command torque command torque T_{rL1} to the disturbance sensitivity controller 290.

The transfer function of the second control target 580 described above, that is, the transfer function G_{θ}^{γ}(s) of a characteristic of the vehicle V, is expressed by Expression (14) below.

$$\begin{matrix}Expression 14 & \\ \frac{γ}{{θ}_{t}} = {G}_{θ}^{γ} ( s ) = {G}_{θ}^{γ} ( 0 ) \frac{1 + {T}_{g} s}{1 + \frac{2 ξ}{{ω}_{n}} s + \frac{{s}^{2}}{{ω}_{n}^{2}}} & ( 14 )\end{matrix}$$

where, s represents a Laplace transformer, w represents a parameter of responsiveness, ζ (represents a parameter of a damping ratio (damping), G_{θ}^{γ}(0) represents a constant determined from specifications of the vehicle V, and T_{g} represents a constant determined from specifications of the vehicle V and the traveling speed Vᵥ of the vehicle V.

The second state feedback loop 242 feeds back the state feedback torque T_{fb} calculated by multiplying a state feedback gain K_{d}, so that the parameter δ of a damping ratio in Expression (14) above can be controlled. When the parameter δ of a damping ratio is set to 1 by the second state feedback loop 242, the right term of Expression (14) described above can be approximated by a transfer function with a primary delay as in Expression (15) below.

$$\begin{matrix}Expression 15 & \\ {G}_{θ}^{γ} ( 0 ) \frac{1 + {T}_{g} s}{1 + \frac{2 ξ}{{ω}_{n}} s + \frac{{s}^{2}}{{ω}_{n}^{2}}} ∼ \frac{{G}_{θ}^{γ} ( 0 )}{\frac{1}{2 π {f}_{γ}} s + 1} & ( 15 )\end{matrix}$$

where, f_{γ} represents a natural frequency of the yaw rate γ.

Since the transfer function of the second control target 580 can be approximated as in Expression (15) above, the second control target 580 can be easily constrained to the second nominal model NM2 having the transfer function Pₙᵥ(s) shown in Expression (11) above. Further, since the second nominal model NM2 can be expressed by a transfer function with a primary delay as in Expression (11), if a plant characteristic of the second control target 580 changes due to a change in the number of passengers of the vehicle V or the like, the natural frequency f_{γ} of the yaw rate γ can be constrained to the desired parameter fᵣ by the second nominal model NM2. As described above, in the present example embodiment, the characteristic of the vehicle V that is stable and easy to steer can be realized by a combination of state feedback by the second state feedback loop 242 and model following control by the second model following controller 241.

For example, in a case where a modeling error between the second control target 580 and the second nominal model NM2 is large only by changing the natural frequency f_{γ} of the yaw rate γ by constraining the second control target 580 to the second nominal model NM2 by the model following control, there is a case where robust stability is lowered, and the natural frequency f_{γ} of the yaw rate γ cannot be adjusted to a desired characteristic. On the other hand, in the present example embodiment, by adjusting the state feedback gain K_{d} of the second state feedback loop 242 in the vehicle stabilization controller 240 and linearly approximating the transfer function G_{θ}^{γ}(s) of the second control target 580 as described above, the transfer function G_{θ}^{γ}(s) of the second control target 580 can be brought close to the transfer function Pₙᵥ(s) of the second nominal model NM2, and a modeling error can be reduced. By the above, the natural frequency f_{γ} of the yaw rate γ that is stable and desirable can be realized by performing model following control in the second model following controller 241. Note that a relationship between a modeling error and robust stability in model following control will be described in detail in model following control by a first model following controller 230 described later.

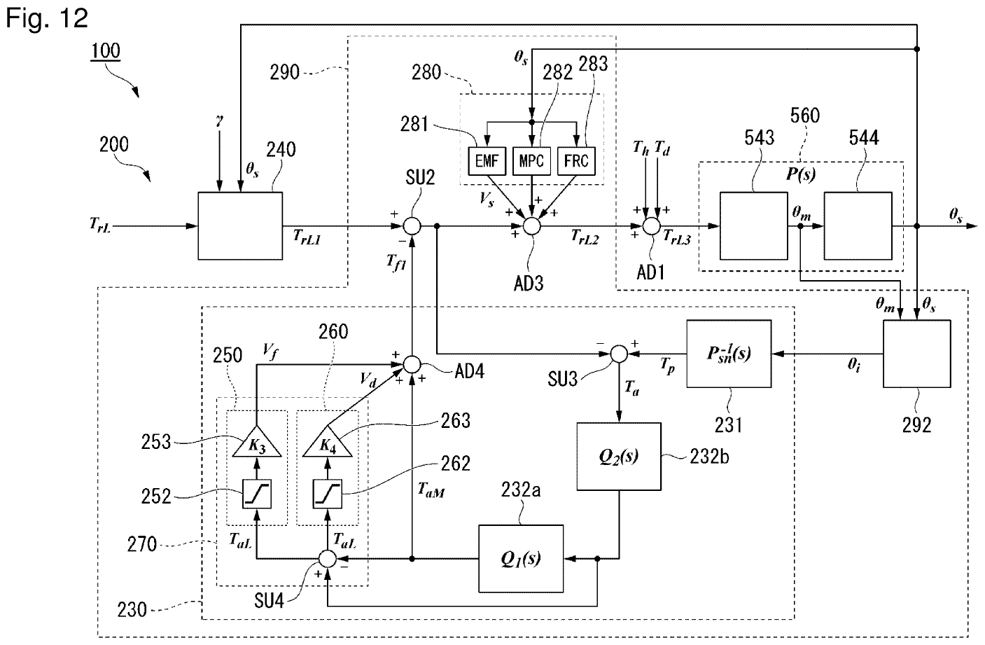

As illustrated in FIG. 12, the command torque T_{rL1} output from the vehicle stabilization controller 240 is input to the disturbance sensitivity controller 290. The disturbance sensitivity controller 290 includes the first model following controller 230, a first state feedback loop 280, a calculator 292, an adder AD3, and a subtractor SU2.

The first model following controller 230 generates a first correction torque T_{f1} to correct the command torque T_{rL1} based on the first nominal model NM1 based on the configuration of the first control target 560. In the present example embodiment, the first correction torque T_{f1} is a “correction value” to correct the command torque T_{rL1} that is a command value. In a case where the command value is an angle, the correction value is an angle. The first correction torque T_{f1} is a feedback torque fed back to the command torque T_{rL1}. The first nominal model NM1 is an internal model used as a model that constrains the first control target 560 when the first control target 560 is controlled. The first nominal model NM1 will be described in detail later. The first model following controller 230 is a model following controller configured to perform model following control. A specific configuration of the first model following controller 230 will be described in detail later.

The subtractor SU2 subtracts the first correction torque T_{f1} output from the first model following controller 230 from the command torque T_{rL1}. An output from the subtractor SU2 is input to the adder AD3 and the first model following controller 230. The adder AD3 outputs a command torque T_{rL2}, which is a value obtained by adding the output from the first state feedback loop 280 to the output from the subtractor SU2, to the adder AD1. The adder AD1 outputs a command torque T_{rL3}, which is a value obtained by adding the steering torque Tₕ and a disturbance torque T_{d} to the output from the adder AD3, to the first control target 560. The first control target 560 is a control target whose input is the command torque T_{rL3} and whose output is the steering angle θ₃. As illustrated in FIG. 9, the steering angle θₛ output from the first control target 560 is input to a conversion unit 570. The conversion unit 570 multiplies the steering angle θₛ by the conversion gain 1/gₜₒₜ to output the actual steering angle θₜ. The actual steering angle θₜ output from the conversion unit 570 is input to the second control target 580. Note that, in FIG. 4, the first control target 560, the conversion unit 570, and the second control target 580 are collectively illustrated as a control target block 590.

The disturbance torque T_{d} is a difference between the actual output torque of the motor 543 and the ideal output torque of the motor 543. The disturbance torque T_{d} includes a disturbance torque externally applied to the first control target 560. The disturbance torque T_{d} includes, for example, an extra torque generated by friction and backlash due to mechanical elements such as the motor 543 and the decelerator 544, a torque ripple generated in the motor 543, the self-aligning torque T_{SAT}, and a disturbance torque that may be generated when traveling on an unpaved rattling road, a gravel road, or the like.

As illustrated in FIG. 12, in the present example embodiment, the first model following controller 230 generates the first correction torque T_{f1} based on a third input value θᵢ output from the calculator 292, and feeds back the first correction torque T_{f1} to the command torque T_{rL1}. The first model following controller 230 includes a first inverse nominal model 231, a first filter 232a, a second filter 232b, an assist adjustment unit 270, a subtractor SU3, and an adder AD4. In the present example embodiment, the first filter 232a is a high-pass filter. The first filter 232a has a first cutoff frequency Cf1. The first cutoff frequency Cf1 is, for example, 2 Hz or higher and 10 Hz or lower. In the present example embodiment, the first cutoff frequency Cf1 is higher than 5 Hz and lower than 10 Hz.

In the present example embodiment, the second filter 232b is a low-pass filter. The second filter 232b has a second cutoff frequency Cf2 higher than the first cutoff frequency Cf1. The second cutoff frequency Cf2 is, for example, 3 Hz or higher and 50 Hz or lower. However, an upper limit of the second cutoff frequency Cf2 may be set in a range of about 140 Hz or higher and 200 Hz or lower. The order of the second filter 232b is third order or more. The second filter 232b may include, for example, a plurality of low-pass filters. The first filter 232a and the second filter 232b are coupled in series.

The first model following controller 230 is configured such that a transfer function Pₛ(s) of the first control target 560 is constrained to a transfer function Pₛₙ(s) of the first nominal model NM1 in a frequency band in which a complementary sensitivity gain GT which is a gain in the gain characteristic of a complementary sensitivity function T(s) with respect to a modeling error between the first control target 560 and the first nominal model NM1 is substantially 1.

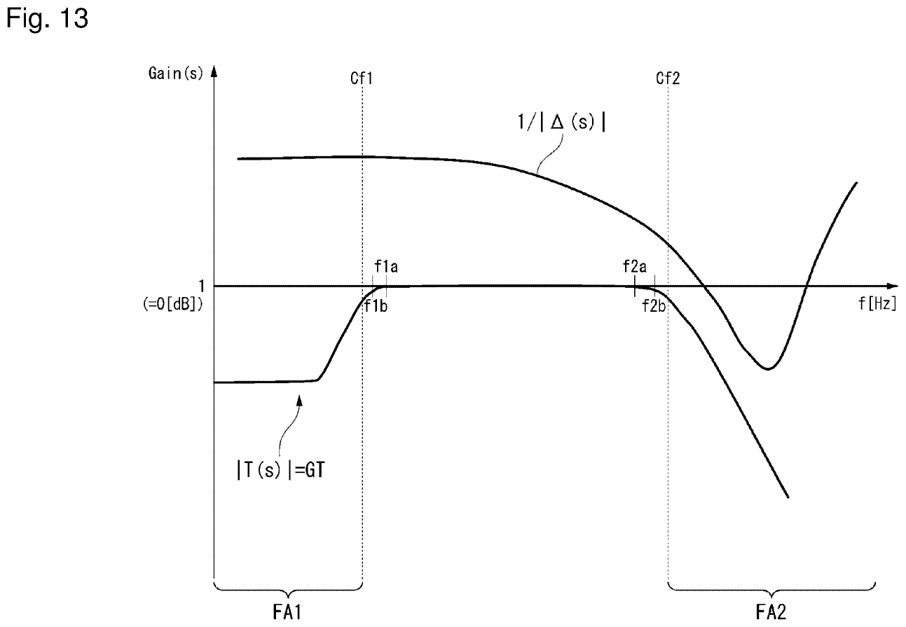

The complementary sensitivity function T(s) is a complementary sensitivity function of an inner loop including the first model following controller 230. FIG. 13 illustrates the complementary sensitivity gain GT in the complementary sensitivity function T(s). The complementary sensitivity gain GT is a gain of the complementary sensitivity function T(s) as a transfer function, and is an absolute value of the complementary sensitivity function T(s). In the graph of FIG. 13, the horizontal axis represents the frequency f [Hz], and the vertical axis represents the complementary sensitivity gain GT. As illustrated in FIG. 13, in the complementary sensitivity function T(s), the gain is substantially 0 dB in at least a part of the frequency band where the frequency f is equal to or higher than the first cut-off frequency Cf1 and equal to or lower than the second cut-off frequency Cf2, that is, the complementary sensitivity gain GT in the transfer function is substantially 1. In the example of FIG. 13, the complementary sensitivity gain GT is 1 in a frequency band that is equal to or higher than the frequency f1a higher than the first cut-off frequency Cf1 and equal to or lower than the frequency f2a lower than the second cut-off frequency Cf2. The frequency f1a is lower than the frequency f2a. In the frequency band of the frequency f1a or higher and the frequency f2a or lower, the complementary sensitivity gain GT may be, for example, a value of 0.95 or larger and smaller than 1. The complementary sensitivity gain GT at the first cutoff frequency Cf1 is smaller than the complementary sensitivity gain GT at the frequency f1a. The complementary sensitivity gain GT at the second cutoff frequency Cf2 is smaller than the complementary sensitivity gain GT at the frequency f2a. In the present example embodiment, the frequency band in which the complementary sensitivity gain GT is substantially 1 is a frequency band of the frequency f1b or higher and the frequency f2b or lower. The frequency f1b is higher than the first cutoff frequency Cf1 and lower than the frequency f1a. The frequency f2b is lower than the second cutoff frequency Cf2 and higher than the frequency f2a. In the frequency band of the frequency f1b or higher and the frequency f2b or lower, the complementary sensitivity gain GT is, for example, 0.8 or larger and 1 or smaller.

The transfer function Pₛ(s) of the first control target 560 is a plant characteristic for which model following control is performed. The transfer function Pₛ(s) of the first control target 560 is expressed by, for example, Expression (16) below.

$$\begin{matrix}Expression 16 & \\ {P}_{s} ( s ) = \frac{1}{J {s}^{2} + B s + {K}_{SAT}} & ( 16 )\end{matrix}$$

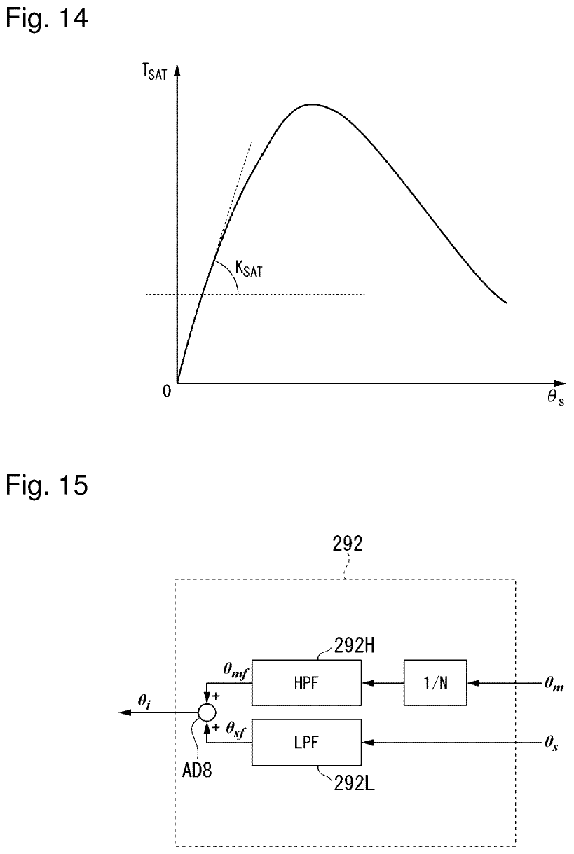

Here, s represents a Laplace transformer, J is a parameter representing the moment of inertia of the steering mechanism unit 520, and B is a parameter representing a viscous friction coefficient of the steering mechanism unit 520. K_{SAT} represents a self-aligning torque gain. The self-aligning torque gain K_{SAT} is an inclination of the self-aligning torque T_{SAT} generated in the tires 529A and 529B of the vehicle V with respect to the steering angle θ₃. FIG. 14 illustrates an example of the relationship between the self-aligning torque T_{SAT} and the steering angle θₛ. In the graph of FIG. 14, the horizontal axis represents the steering angle θₛ, the vertical axis represents the self-aligning torque T_{SAT}, and an inclination of the self-aligning torque T_{SAT} with respect to the steering angle θₛ is the self-aligning torque gain K_{SAT}. The steering angle θ₃, the self-aligning torque T_{SAT}, and the self-aligning torque gain K_{SAT} satisfy the relationship of dT_{SAT}/dθₛ=K_{SAT}. As illustrated in FIG. 14, for example, the self-aligning torque T_{SAT} becomes larger as the steering angle θₛ becomes larger up to a certain degree of the steering angle θₛ, and becomes smaller as the steering angle θₛ becomes larger when the steering angle θₛ becomes a certain degree or more.

The first inverse nominal model 231 is an inverse model of the first nominal model NM1 used to constrain the first control target 560. The transfer function Pₛₙ(s) of the first nominal model NM1 is expressed by, for example, Expression (17) below. A transfer function Pₛₙ⁻¹(s) of the first inverse nominal model 231 is expressed by, for example, Expression (18) below.

$$\begin{matrix}Expression 17 & \\ {P}_{s n} ( s ) = \frac{1}{{J}_{n} {s}^{2} + {B}_{n} s} & ( 17 )\end{matrix}$$

$$\begin{matrix}Expression 18 & \\ {P}_{s n}^{- 1} ( s ) = {J}_{n} {s}^{2} + {B}_{n} s & ( 18 )\end{matrix}$$

In Expressions (17) and (18), s represents a Laplace transformer, Jₙ represents a parameter representing the moment of inertia of the first nominal model NM1, and Bₙ represents a parameter representing a viscous friction coefficient of the first nominal model NM1. Note that the transfer function Pₛₙ(s) of the first nominal model NM1 and the transfer function Pₛₙ⁻¹(s) of the first inverse nominal model 231 are not limited to the examples illustrated in Expression (17) and (18), and are not particularly limited.

As illustrated in FIG. 12, the third input value θ₁, which is an output from the calculator 292, is input to the first inverse nominal model 231. That is, in the present example embodiment, the third input value θ₁ is input to the first model following controller 230. The first inverse nominal model 231 outputs a torque Tₚ based on the above Expression (18) and the input third input value θᵢ. That is, the first model following controller 230 calculates the torque Tₚ using the first nominal model NM1 based on the output from the calculator 292. The torque Tₚ is equal to the value of the torque input to the first nominal model NM1 in a case where an output value of the first nominal model NM1 is the same value as an output value of the first control target 560.

The subtractor SU3 subtracts the output of the subtractor SU2 from the output of the first inverse nominal model 231 to generate a differential torque Tₐ. That is, the subtractor SU3 subtracts, from the torque Tₚ, the command torque T_{rL1} before a state compensation value Vₛ described later is fed back after the first correction torque T_{f1} is fed back, to generate the differential torque Tₐ. The differential torque Tₐ is, for example, an estimated value of the disturbance torque T_{d}. The differential torque Tₐ output from the subtractor SU3 is input to the second filter 232b and subjected to low-pass filter processing, and then input to the first filter 232a and subjected to high-pass filter processing. The differential torque Tₐ subjected to filter processing by the first filter 232a and the second filter 232b is input to the adder AD4. The differential torque Tₐ subjected to filter processing by the first filter 232a and the second filter 232b is in a state in which a frequency component lower than the first cutoff frequency Cf1 and a frequency component higher than the second cutoff frequency Cf2 are removed. That is, the differential torque Tₐ subjected to filter processing by the first filter 232a and the second filter 232b is a frequency component T_{aM} equal to or higher than the first cutoff frequency Cf1 and equal to or lower than the second cutoff frequency Cf2.

The assist adjustment unit 270 generates a compensation value for friction and disturbance and adjusts the differential torque Tₐ. In the present example embodiment, the assist adjustment unit 270 adjusts the frequency component T_{aM} in the differential torque Tₐ. The assist adjustment unit 270 is coupled in parallel to the first filter 232a. The assist adjustment unit 270 includes a friction compensation value calculator 250, a disturbance compensation value calculator 260, and a subtractor SU4.

The subtractor SU4 subtracts an output value from the first filter 232a from an output value from the second filter 232b. Here, an output value from the second filter 232b is a value obtained by removing a frequency component higher than the second cutoff frequency Cf2 from the differential torque Tₐ. An output value from the first filter 232a is a value obtained by removing a frequency component higher than the second cutoff frequency Cf2 and a frequency component lower than the first cutoff frequency Cf1 from the differential torque Tₐ. Therefore, a value output from the subtractor SU4 is a frequency component T_{aL} lower than the first cutoff frequency Cf1 in the differential torque Tₐ. An output of the subtractor SU4 is input to the friction compensation value calculator 250 and the disturbance compensation value calculator 260. The frequency component T_{aL} includes a frictional force, the self-aligning torque T_{SAT}, a disturbance torque caused by backlash of the first control target 560, a torque ripple generated in the first control target 560, and the like.

The friction compensation value calculator 250 calculates a friction compensation value V_{f} that compensates at least a part of the frictional force generated in the first control target 560, based on the differential torque Tₐ. As described above, a value from the subtractor SU4 input to the friction compensation value calculator 250 is the frequency component T_{aL} lower than the first cutoff frequency Cf1 in the differential torque Tₐ. Therefore, in the present example embodiment, the friction compensation value calculator 250 calculates the friction compensation value V_{f} based on the component having a frequency lower than the first cutoff frequency Cf1 in the differential torque Tₐ.

The friction compensation value calculator 250 includes a limiter 252 and a gain adjuster 253. The limiter 252 limits an output value from the subtractor SU4. The limiter 252 clips the input value to the upper or lower threshold when the input value exceeds the upper or lower threshold. The gain adjuster 253 applies a gain K₃ to an output value from the limiter 252. The friction compensation value calculator 250 calculates the friction compensation value V_{f} by applying a limit by the limiter 252 and the gain K₃ to a component of a frequency lower than the first cutoff frequency Cf1 in the differential torque Tₐ. A threshold of the limiter 252 and the value of the gain K₃ are determined in advance based on, for example, the frictional force actually generated in the first control target 560.

The friction compensation value V_{f} output from the friction compensation value calculator 250 is a value that compensates for at least a part of the frictional force component included in the frequency component T_{aL} of the differential torque Tₐ. In general, since appropriate friction is required for the first control target 560, the friction compensation value calculator 250 calculates a value smaller than the frictional force actually generated in the first control target 560 as the friction compensation value V_{f}. This makes it possible to achieve highly accurate friction compensation while maintaining appropriate frictional force on the first control target 560. A target of friction compensation using the friction compensation value V_{f} is, for example, friction of the motor 543, friction of the decelerator 544, a difference between right and left in friction of the decelerator 544, and the like.

The vehicle V equipped with the electric power steering device 1000 can travel according to a travel mode having an automatic driving mode and a manual driving mode. In this case, the gain K₃ of the gain adjuster 253 may be switched according to the travel mode. The greater the gain K₃ of the gain adjuster 253, the greater the degree of friction reduction.

The disturbance compensation value calculator 260 calculates a disturbance compensation value V_{d} for compensating at least a part of the self-aligning torque T_{SAT} generated in the first control target 560. In the present example embodiment, the disturbance compensation value V_{d} includes a compensation value for compensating at least a part of the frictional force generated in the first control target 560, a disturbance torque caused by backlash generated in the first control target 560, and a torque ripple generated in the first control target 560. The disturbance compensation value calculator 260 calculates the disturbance compensation value V_{d} based on the differential torque Tₐ that is a difference between the torque Tₚ output from the first inverse nominal model 231 and the command torque T_{rL1}. That is, the disturbance compensation value calculator 260 calculates the disturbance compensation value V_{d} based on the differential torque Tₐ that is a difference between the torque Tₚ calculated using the first nominal model NM1 based on the output of the first control target 560 and the command torque T_{rL1}. As described above, a value from the subtractor SU4 input to the disturbance compensation value calculator 260 is a frequency component lower than the first cutoff frequency Cf1 in the differential torque Tₐ. Therefore, in the present example embodiment, the disturbance compensation value calculator 260 calculates the disturbance compensation value V_{d} based on a component having a frequency lower than the first cutoff frequency Cf1 in the differential torque Tₐ.

The disturbance compensation value calculator 260 includes a limiter 262 and a gain adjuster 263. The limiter 262 limits an output value from the subtractor SU4. The limiter 262 clips the input value to the upper or lower threshold when the input value exceeds the upper or lower threshold. The threshold of the limiter 262 is different from the threshold of the limiter 252, for example. The gain adjuster 263 applies a gain K₄ to an output value from the limiter 262. A maximum value of the gain K₄ of the gain adjuster 263 is determined under a condition that the transfer function Pₛ(s) of the first control target 560 is constrained to the transfer function Pₛₙ(s) of the first nominal model NM1. A value of the gain K₄ is different from a value of the gain K₃, for example. A value of the gain K₄ is, for example, about 0.1 or more and 0.8 or less in the manual driving mode. A value of the gain K₄ is, for example, substantially 1 in the automatic driving mode. That a value of the gain K₄ is substantially 1 includes that a value of the gain K₄ is 0.8 or more and 1 or less. The gain K₄ of the gain adjuster 263 may be switched according to the travel mode of the vehicle V.

The disturbance compensation value V_{d} is a value that compensates for at least a part of a self-aligning torque component included in the frequency component T_{aL} of the differential torque Tₐ. For example, the disturbance compensation value calculator 260 calculates a value corresponding to about half of the self-aligning torque T_{SAT} actually generated in the first control target 560 as the disturbance compensation value V_{d}. The self-aligning torque T_{SAT} actually generated in the first control target 560 is experimentally obtained in advance for each frequency, for example. A threshold of the limiter 262 of the disturbance compensation value calculator 260 and a value of the gain K₄ are adjusted to a value at which the disturbance compensation value V_{d} is calculated as a value about 0.1 times or more and 0.8 times or less the magnitude of the self-aligning torque T_{SAT} obtained in advance in the manual driving mode. A threshold of the limiter 262 of the disturbance compensation value calculator 260 and a value of the gain K₄ are adjusted to a value at which the disturbance compensation value V_{d} is calculated as a value substantially one time, that is, approximately 0.8 times or more and one time or less the magnitude of the self-aligning torque T_{SAT} obtained in advance in the automatic driving mode. The disturbance compensation value V_{d} calculated by the disturbance compensation value calculator 260 is a value different from the friction compensation value V_{f} calculated by the friction compensation value calculator 250.

Here, the frequency component T_{aL} of the differential torque Tₐ includes the frictional force generated in the first control target 560, the self-aligning torque T_{SAT} generated in the first control target 560, the disturbance torque caused by the backlash generated in the first control target 560, and the torque ripple generated in the first control target 560. For this reason, the friction compensation value V_{f} obtained by processing of the frequency component T_{aL} by the limiter 252 and the gain adjuster 253 also includes a compensation value for compensating at least a part of the self-aligning torque T_{SAT} generated in the first control target 560, the disturbance torque caused by backlash generated in the first control target 560, and the torque ripple generated in the first control target 560. In addition, the disturbance compensation value V_{d} obtained by processing the frequency component T_{aL} by the limiter 262 and the gain adjuster 263 also includes a compensation value for compensating at least a part of the disturbance other than the self-aligning torque T_{SAT}, that is, the frictional force generated in the first control target 560, the disturbance torque caused by backlash generated in the first control target 560, and the torque ripple generated in the first control target 560.

In order to apply friction compensation and disturbance compensation performed in the assist adjustment unit 270 to the first correction torque T_{f1} used for model following control in the first model following controller 230, it is necessary to pay attention to a stability condition of the model following control. This condition is that the gain in the gain characteristic of the transfer function of the assist adjustment unit 270 constrained to the characteristic considering stability does not exceed 1 according to the small gain theorem described later. This is derived from the design condition of the second filter 232b. In the present example embodiment, the subtractor SU4 is provided in a preceding stage of the limiters 252 and 262 so that values of the gains K₃ and K₄ in the gain adjusters 253 and 263 are set to 1 at the maximum and a gain in the gain characteristic becomes 1 under this condition, and subtraction processing is applied. In other words, the assist adjustment unit 270 behaves as a low-pass filter having a transfer function of 1−Q₁(s). Q₁(s) is a transfer function of the first filter 232a that is a high-pass filter. The assist adjustment unit 270 performs low-pass filter processing having a transfer function of 1−Q₁(s) on the torque output from the second filter 232b, and adjusts the value applied with the processing in each of the friction compensation value calculator 250 and the disturbance compensation value calculator 260 and outputs the value.

Note that, for example, the values of the gains K₃ and K₄ are determined such that 100% of a frictional force component is compensated for in both the manual driving mode and the automatic driving mode. Here, a target to be compensated by the friction compensation value calculator 250 is only a frictional force component, whereas a target to be compensated by the disturbance compensation value calculator 260 is all the disturbances including a frictional force component. In the automatic driving mode, for example, since it is preferable to compensate for substantially all disturbances, the gain K₄ of the disturbance compensation value calculator 260 is substantially 1. In this case, since substantially all frictional force components are also compensated by compensation by the disturbance compensation value calculator 260, the gain K₃ of the friction compensation value calculator 250 is zero. On the other hand, in the manual driving mode, it is preferable to compensate for a frictional force component by 100% while making it easier for a steering operator to drive the vehicle V by leaving a part of the tire reaction force including the self-aligning torque T_{SAT} and the like. For this reason, in the manual driving mode, the gain K₄ of the disturbance compensation value calculator 260 is preferably set to be smaller than 1, and a frictional force component that is not compensated by the disturbance compensation value calculator 260 is preferably compensated by the friction compensation value calculator 250. For example, in a case where the gain K₄ of the disturbance compensation value calculator 260 is 0.8 in the manual driving mode, the gain K₃ of the friction compensation value calculator 250 is set to 0.2, and the friction compensation value calculator 250 compensates for 20% of the frictional force component that is not compensated by the disturbance compensation value calculator 260.

The adder AD4 adds an output value from the assist adjustment unit 270 to an output value from the first filter 232a. That is, the adder AD4 adds the friction compensation value V_{f} and the disturbance compensation value V_{d} to the frequency component T_{aM}. The adder AD4 outputs the first correction torque T_{f1} calculated by adding the frequency component T_{aM}, the friction compensation value V_{f}, and the disturbance compensation value V_{d}. The first correction torque T_{f1} output from the adder AD4 is fed back to the input of the first control target 560, that is, the command torque T_{rL1}. As described above, in the present example embodiment, the first model following controller 230 generates the first correction torque T_{f1} by adding the friction compensation value V_{f} and the disturbance compensation value V_{d} to the differential torque Tₐ from which a frequency component lower than the first cutoff frequency Cf1 is removed by the first filter 232a which is a high-pass filter, that is, the frequency component T_{aM}.

The first state feedback loop 280 feeds back a state compensation value Vₛ to the command torque T_{rL1} so that an apparent transfer function of the first control target 560 approaches the transfer function Pₛₙ(s) of the first nominal model NM1, based on the output of the first control target 560. The apparent transfer function of the first control target 560 is, for example, a transfer function of one portion in a case where a portion located inside a feedback loop formed by the first model following controller 230 is regarded as the one portion. Specifically, in the present example embodiment, the apparent transfer function of the first control target 560 is a transfer function of an entire portion from the subtractor SU2 to the output of the first control target 560, and is a transfer function of a portion combining the first state feedback loop 280 and the first control target 560. In the present example embodiment, the first state feedback loop 280 feeds back the state compensation value Vₛ to the command torque T_{rL1} after being corrected by the first correction torque T_{f1} and before being input to the first control target 560.

The state compensation value Vₛ includes a compensation value for compensating at least a part of the inertial force generated in the first control target 560, the viscous force generated in the first control target 560, and the frictional force generated in the first control target 560. More specifically, the state compensation value Vₛ includes a compensation value that compensates at least a part of the inertial force generated in the motor 543, the viscous force generated in the motor 543, and the frictional force generated in the motor 543. In the present example embodiment, the state compensation value Vₛ is a compensation value including the inertial force generated in the motor 543, the viscous force generated in the motor 543, and the frictional force generated in the motor 543.

The first state feedback loop 280 includes an inertia compensator 281, a viscosity compensator 282, and a friction compensator 283. The inertia compensator 281 calculates a compensation value for compensating at least a part of the inertial force generated in the motor 543 based on the steering angle θₛ. The viscosity compensator 282 calculates a compensation value for compensating at least a part of the viscous force generated in the motor 543 based on the steering angle θ₃. The friction compensator 283 calculates a compensation value for compensating at least a part of the frictional force generated in the motor 543 based on the steering angle θₛ. In the present example embodiment, the state compensation value Vₛ includes a compensation value calculated by the inertia compensator 281, a compensation value calculated by the viscosity compensator 282, and a compensation value calculated by the friction compensator 283. A compensation value calculated by the inertia compensator 281, a compensation value calculated by the viscosity compensator 282, and a compensation value calculated by the friction compensator 283 are output to the adder AD3 and added to the command torque T_{rL1} corrected by the first correction torque T_{f1}.

The calculator 292 outputs the third input value θᵢ to be input to the first model following controller 230, based on the output from the first control target 560. In the present example embodiment, the output from the first control target 560 includes the rotation angle θₘ of the motor 543 acquired based on the angle sensor 112 and the steering angle θₛ acquired based on the steering torque sensor 541 and the steering angle sensor 542. The rotation angle θₘ and the steering angle θₛ are input to the calculator 292. As illustrated in FIG. 15, the calculator 292 includes a high-pass filter unit 292H and a low-pass filter unit 292L. The rotation angle θₘ input to the calculator 292 is divided by the reduction ratio N of the decelerator 544, and then subjected to high-pass filter processing in the high-pass filter unit 292H to become a high-frequency output value G_{mf}. The reduction ratio N is a value obtained by dividing the rotational angular velocity of the motor 543 by the rotational angular velocity of the output of the decelerator 544. The reduction ratio N, the rotation angle θₘ of the motor 543, and the steering angle θₛ satisfy a relationship of N=θₘ/θₛ. The high-frequency output value θ_{mf} is a value obtained by performing high-pass filter processing and division processing of dividing the rotation angle θₘ, which is the first output value, by the reduction ratio N of the decelerator 544. The steering angle θₛ input to the calculator 292 is subjected to low-pass filtering processing in the low-pass filter unit 292 L to become a low-frequency output value θ_{sf}. The low-frequency output value θ_{sf} is a value obtained by performing low-pass filtering processing on the steering angle θₛ that is the second output value. The low-pass filter processing performed in the low-pass filter unit 292L in the present example embodiment corresponds to “second low-pass filter processing”.

In the present example embodiment, the cutoff frequency of the high-pass filter unit 292H and the cutoff frequency of the low-pass filter unit 292L are the same. That is, in the present example embodiment, the cutoff frequency in the high-pass filter processing performed by the calculator 292 is the same as the cutoff frequency in the low-pass filter processing performed by the calculator 292. In the following description, the cutoff frequency of the high-pass filter unit 292H and the cutoff frequency of the low-pass filter unit 292L are referred to as a cutoff frequency Cf3. The cutoff frequency Cf3 is lower than the first cutoff frequency Cf1. The cutoff frequency Cf3 ranges from 0.05 Hz to 50 Hz inclusive. In the present example embodiment, the cutoff frequency Cf3 ranges from 0.05 Hz to 30 Hz inclusive. More specifically, the cutoff frequency Cf3 is 5 Hz or less.

Note that “the cutoff frequency in the high-pass filter processing is the same as the cutoff frequency in the low-pass filter processing” includes not only the case where the cutoff frequency in the high-pass filter processing and the cutoff frequency in the low-pass filter processing are exactly the same as each other, but also the case where the cutoff frequencies are substantially the same as each other. The phrase “the cutoff frequency in the high-pass filter processing and the cutoff frequency in the low-pass filter processing are substantially the same” includes that the cutoff frequency in the high-pass filter processing and the cutoff frequency in the low-pass filter processing are different from each other within a tolerance range such as manufacturing variation of the filter that performs each filter processing.

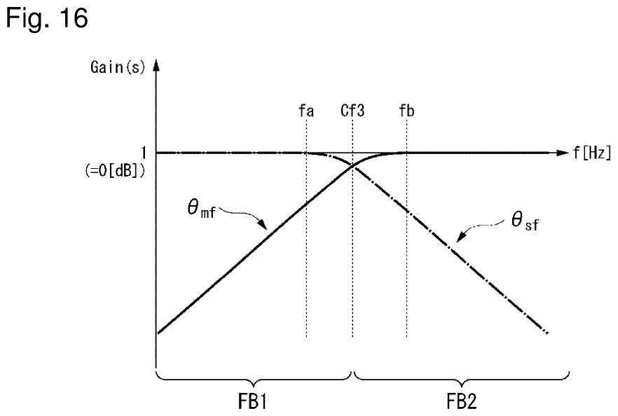

The gain of the high frequency output value θ_{mf} and the gain of the low frequency output value θ_{sf} have, for example, frequency characteristics as illustrated in the graph of FIG. 16. In the graph of FIG. 16, the horizontal axis represents the frequency f [Hz], and the vertical axis represents the gain of each output value. As illustrated in FIG. 16, a frequency band equal to or lower than the cutoff frequency Cf3 is a first frequency band FB1. A frequency band higher than the cutoff frequency Cf3 is a second frequency band FB2.

The gain of the high frequency output value θ_{mf} in the first frequency band FB1 is smaller than the gain of the high frequency output value θ_{mf} in the second frequency band FB2. The gain of the high frequency output value θ_{mf} at the cutoff frequency Cf3 is smaller than 1. The gain of the high frequency output value θ_{mf} at the cutoff frequency Cf3 is, for example, 1/√2, that is, −3 [dB]. The gain of the high frequency output value θ_{mf} is 1 in a frequency band equal to or higher than the frequency fb higher than the cutoff frequency Cf3. In a frequency band lower than the frequency fb, the gain of the high frequency output value θ_{mf} decreases as the frequency f decreases.

The gain of the low frequency output value θ_{f} in the second frequency band FB2 is smaller than the gain of the low frequency output value θ_{sf} in the first frequency band FB1. The gain of the low frequency output value θ_{sf} at the cutoff frequency Cf3 is smaller than 1. In the example of FIG. 16, the gain of the low frequency output value θ_{sf} at the cutoff frequency Cf3 is the same as the gain of the high frequency output value θ_{mf} at the cutoff frequency Cf3. The gain of the low frequency output value θ_{sf} at the cutoff frequency Cf3 is, for example, 1/√2, that is, −3 [dB]. The gain of the low frequency output value θ_{f} is 1 in a frequency band equal to or lower than the frequency fa lower than the cutoff frequency Cf3. In a frequency band higher than the frequency fa, the gain of the low frequency output value θ_{sf} decreases as the frequency f increases.

As illustrated in FIG. 15, in the calculator 292, the high-frequency output value θ_{mf} and the low-frequency output value θ_{sf} are added together by an adder AD8. The adder AD8 adds the high frequency output value θ_{mf} and the low frequency output value θ_{sf} and outputs the added value as the third input value θ₁. In this manner, the calculator 292 calculates the third input value θ₁ by adding the high-frequency output value θ_{mf} obtained by performing the high-pass filter processing on the rotation angle θₘ and the division processing to divide the rotation angle θₘ by the reduction ratio N and the low-frequency output value d_{sf} obtained by performing the low-pass filter processing on the steering angle θₛ. In other words, the control method of controlling the first control target 560 includes calculating the third input value θᵢ by adding the high frequency output value θ_{mf} and the low frequency output value θ_{sf}.

Next, control by the first model following controller 230 will be described in more detail. The first model following controller 230 controls the first control target 560 by using an inverse model of the first nominal model NM1 included as an internal model, that is, the first inverse nominal model 231. In the present example embodiment, a torque ripple or the like depending on the angular velocity of the motor 543 can be compensated by a feedback loop formed by the first model following controller 230.

The first model following controller 230 is structurally similar to a conventional disturbance estimator (disturbance observer), but has different actions and effects. A conventional disturbance estimator estimates a disturbance torque by using an inverse plant model as an internal model as a model close to the first control target 560, and reduces influence of disturbance by adjusting the disturbance torque in advance.

Control by the first model following controller 230 according to the present example embodiment utilizes an effect that the transfer function Pₛ(s) of the first control target 560 is constrained to the transfer function Pₛₙ(s) of the first nominal model NM1 included as an internal model by a feedback loop. For example, if the first nominal model NM1 is defined such that there is no torque ripple, the transfer function Pₛ(s) of the first control target 560 is constrained to a characteristic without a torque ripple by model following control. As a result, a torque ripple can be reduced by applying torque ripple compensation. Further, the first control target 560 can be treated as a low inertia model by setting the first nominal model NM1 as a low inertia model and constraining the first control target 560 to the first nominal model NM1. Further, the first control target 560 can be treated as a low viscosity model by setting the first nominal model NM1 as a low viscosity model and constraining the first control target 560 to the first nominal model NM1. By the first model following controller 230 executing model following control, for example, lost torque compensation or motor inertia compensation is performed in addition to compensation of a torque ripple of the motor 543. By appropriately setting Jₙ and Bₙ in Expressions (17) and (18) described above, a desired frequency characteristic can be given to the transfer function Pₛ(s) of the first control target 560.

When a modeling error between the transfer function Pₛ(s) of the first control target 560 and the transfer function Pₛₙ(s) of the first nominal model NM1 is Δ(s), the transfer function Pₛ(s) of the first control target 560 is expressed by Expression (19) below.

$$\begin{matrix}Expression 19 & \\ {P}_{s} ( s ) = \frac{1}{{J}_{n} {s}^{2} + {B}_{n} s} ( 1 + Δ ( s ) ) & ( 19 )\end{matrix}$$

Note that the transfer function Pₛ(s) of the first control target 560, that is, a plant characteristic in model following control of the first model following controller 230, is not limited to the example of Expression (19) above, and may be expressed in any manner. The transfer function Pₛ(s) of the first control target 560 may be expressed as a two-inertia system, or may be expressed by an expression derived by high-order approximation.

A gain characteristic of the transfer function Pₛ(s) of the first control target 560 has peaks at two frequency values, for example. The modeling error Δ(s) appears, for example, near a higher frequency peak of the two peaks in the gain characteristic of the first control target 560. For this reason, as illustrated in FIG. 13, the reciprocal 1/Δ(s) of the modeling error Δ(s) has a bottom in a relatively high frequency domain. In FIG. 13, the modeling error Δ(s) is indicated by an absolute value. When the modeling error Δ(s) is large, a deviation between the transfer function Pₛ(s) of the first control target 560 and the transfer function Pₛₙ(s) of the first nominal model NM1 becomes large, and control of the first control target 560 using the first nominal model NM1 by the first model following controller 230 becomes unstable. For this reason, in a domain where the modeling error Δ(s) is relatively small, the first control target 560 can be stably and suitably controlled by setting a gain of the complementary sensitivity function T(s) to be substantially 1 and constraining the first control target 560 to the first nominal model NM1. The frequency characteristic of the modeling error Δ(s) can be adjusted by adjusting Jₙ and Bₙ in the transfer function Pₛₙ(s) of the first nominal model NM1. The frequency band where the gain of the complementary sensitivity function T(s) becomes substantially 1 can be adjusted by adjusting the first cutoff frequency Cf1 and the second cutoff frequency Cf2. Consequently, the gain of the complementary sensitivity function T(s) can be adjusted to be substantially 1 in the frequency band where the modeling error Δ(s) is small.

In FIG. 13, 1/Δ(s) is relatively high in a frequency band of the second cutoff frequency Cf2 or less, and rapidly decreases in a frequency band higher than the second cutoff frequency Cf2. The model following control for constraining the first control target 560 to the first nominal model NM1 can be stably performed, for example, in a range where 1/Δ(s) is larger than 1, that is, in a range larger than 0 dB. For this reason, as illustrated in FIG. 13, by adjusting 1/Δ(s) to be larger than 1 in a frequency band in which a gain of the complementary sensitivity function T(s) is substantially 1, in a case where a gain of the complementary sensitivity function T(s) is substantially 1, the first control target 560 can be constrained to the first nominal model NM1 to be stably and suitably controlled.

For example, in order to expand a frequency band in which the first control target 560 can be constrained to the first nominal model NM1 to be stably and suitably controlled, the second cutoff frequency Cf2 is preferably made high within a range in which 1/Δ(s) is not 1 or less, that is, within a frequency band lower than a frequency at which a curve indicating 1/Δ(s) intersects the horizontal axis in FIG. 13. However, if the second cutoff frequency Cf2 is made too high, the gain of the complementary sensitivity function T(s) remains relatively high even though 1/Δ(s) becomes low in a frequency band higher than the second cutoff frequency Cf2, and control may become unstable. On the other hand, in the present example embodiment, since the order of the second filter 232b, which is a low-pass filter, is set to third order or more, the gain of the complementary sensitivity function T(s) can be steeply decreased in a region where the frequency is higher than the second cutoff frequency Cf2. As a result, if the second cutoff frequency Cf2 is made relatively high, a gain of the complementary sensitivity function T(s) can be immediately lowered in a frequency band higher than the second cutoff frequency Cf2, so that control of the first control target 560 can be prevented from becoming unstable.

Robust stability of the first model following controller 230 is guaranteed when a small-gain theorem shown in Expression (20) below is established between the complementary sensitivity function T(s) and the modeling error Δ(s).

$$\begin{matrix}Expression 20 & \\ & \end{matrix}$$

As described above, in order to perform model following control using the first nominal model NM1 in the first model following controller 230, the complementary sensitivity gain GT of the complementary sensitivity function T(s) is preferably substantially 1, but in consideration of robust stability, it is necessary to satisfy Expression (20) above. As understood from this, it is not possible to achieve both setting of the complementary sensitivity gain GT to substantially 1 in all frequency bands and Expression (20), and it is not possible to achieve both reduction in disturbance or the like by the first model following controller 230 and robust stability.

As illustrated in FIG. 13, the complementary sensitivity gain GT of the complementary sensitivity function T(s) is smaller than 1 also in a low frequency domain FA1 where the frequency f is lower than the first cutoff frequency Cf1. In a region where the complementary sensitivity gain GT of the complementary sensitivity function T(s) is smaller than 1, the first control target 560 is controlled by control of the command torque T_{rL1}. As described above, in a high frequency domain FA2 where a frequency is higher than the second cutoff frequency Cf2, the complementary sensitivity gain GT of the complementary sensitivity function T(s) is greatly lowered, and the first correction torque T_{f1} from the first model following controller 230 is hardly fed back to the input of the first control target 560. On the other hand, in the low frequency domain FA1, the complementary sensitivity gain GT of the complementary sensitivity function T(s) is set to a certain magnitude, and the first correction torque T_{f1} is fed back to the input of the first control target 560. In the low frequency domain FA1, a compensation value generated in the assist adjustment unit 270 described above is fed back to the input of the first control target 560 according to the complementary sensitivity gain GT of the complementary sensitivity function T(s). The value of the complementary sensitivity gain GT in the low frequency domain FA1 is, for example, 0.8 or more.

For example, in a case where the communication cycle of signals transmitted from the steering angle sensor 542 to the control device 100 is long, in the model following control performed by the first model following controller 230 of the control device 100, the steering angle θₛ acquired based on the steering angle sensor 542 in a frequency band higher than a frequency that is a reciprocal of the communication cycle may not be used or may be difficult to use. In this case, in a frequency band higher than the frequency that is the reciprocal of the communication cycle, the first model following controller 230 can execute the model following control by using a value obtained by dividing the rotation angle θₘ of the motor 543 by the reduction ratio N of the decelerator 544 as a substitute for the steering angle θₛ acquired based on the steering angle sensor 542. However, in this case, in the model following control, the disturbance from the motor 543 to the output shaft 524b cannot be estimated, and the disturbance cannot be compensated. Specifically, in this case, it is not possible to estimate and compensate for the response delay element C_{L}(s) of the output of the decelerator 544 with respect to the output of the motor 543 described above. Since the lane keeping control executed by the first assist controller 210 is control for controlling the steering angle θₛ to control the steering angle θₕ, there is a problem that responsiveness of the lane keeping control is deteriorated when the disturbance cannot be estimated.

With respect to the above problem, according to the present example embodiment, the control device 100 includes the first assist controller 210 configured or programmed to execute lane keeping control to keep the vehicle V in the lane L and generates the first command torque T_{LKA}, the second assist controller 220 that generates the second command torque Tᵣ based on the steering torque Tₕ input from the steering wheel 521, and the disturbance sensitivity controller 290 to which the command torque T_{rL1} calculated based on the first command torque T_{LKA} and the second command torque Tᵣ is input. The disturbance sensitivity controller 290 includes the first model following controller 230 that generates the first correction torque T_{f1} to correct the command torque T_{rL1} based on the first nominal model NM1 based on the configuration of the first control target 560. The first model following controller 230 includes the first inverse nominal model 231 to which the third input value θᵢ based on the rotation angle θₘ that is an inverse model of the first nominal model NM1 and indicates the output of the motor 543 is input, and is configured such that, in a frequency band in which the complementary sensitivity gain GT that is a gain in the gain characteristic of the complementary sensitivity function T(s) with respect to the modeling error Δ(s) between the first control target 560 and the first nominal model NM1 is substantially 1, the transfer function Pₛ(s) of the first control target 560 is constrained to the transfer function Pₛₙ⁻¹(s) of the first nominal model NM1. The first assist controller 210 includes the first generator 213 that generates the first command torque T_{LKA} based on the target steering angle θₛᵣ that is a target value of the output of the decelerator 544. The steering angle θₛ indicating the output of the decelerator 544 is fed back to the first generator 213. The first generator 213 includes the compensator 214 that performs phase delay compensation processing on a phase delay generated in the fed back steering angle θₛ fed back. In other words, the control method of controlling the first control target 560 includes executing the lane keeping control that generates the first command torque T_{LKA} and keeps the vehicle V in the lane L, generating the second command torque Tᵣ based on the steering torque Tₕ, executing the model following control by the first model following controller 230, and constraining the transfer function Pₛ(s) of the first control target 560 to the transfer function Pₛₙ⁻¹(s) of the first nominal model NM1 in the frequency band in which the complementary sensitivity gain GT is substantially 1 by the model following control. In the model following control by the first model following controller 230, the third input value θᵢ is input to the first inverse nominal model 231. The lane keeping control includes generating the first command torque T_{LKA} based on the target steering angle θₛᵣ, feeding back the steering angle θₛ, and performing phase delay compensation processing on a phase delay generated in the fed back steering angle θ_{S}.

Therefore, the delay with respect to the rotation angle θₘ generated in the steering angle θ^{s} fed back to the first generator 213 of the first assist controller 210 can be compensated by the phase delay compensation processing performed by the compensator 214. As a result, even when the model following control is executed by the first model following controller 230 using the third input value θᵢ based on the rotation angle θₘ of the motor 543, it is possible to suppress deterioration in responsiveness of the lane keeping control in the first assist controller 210. For example, by modeling the response delay element C_{L}(s) described above and designing the phase delay compensation processing performed by the compensator 214 based on the model, it is possible to more suitably suppress deterioration in responsiveness of the lane keeping control.

According to the present example embodiment, the compensator 214 includes the phase delay element 216 that delays the phase of the steering angle θₛ fed back to the first generator 213. In other words, the phase delay compensation processing includes a process of delaying the phase of the steering angle θₛ fed back in the lane keeping control. As described using Expression (8) and the like, when the processing of delaying the phase is performed on the steering angle θₛ subtracted from the target steering angle θₛᵣ, as a result, the effect of phase advance is obtained. Therefore, by providing the phase delay element 216 in the compensator 214, the delay with respect to the rotation angle θₘ generated in the steering angle θₛ fed back to the first generator 213 can be compensated.

According to the present example embodiment, the control device 100 includes the calculator 292 that adds the high-frequency output value θ_{mf} obtained by performing the high-pass filter processing on the rotation angle θₘ and the division processing for dividing the rotation angle θₘ by the reduction ratio N of the decelerator 544 and the low-frequency output value θ_{sf} obtained by performing the low-pass filter processing on the steering angle θₛ to calculate the third input value θ₁. In other words, the control method of controlling the first control target 560 includes calculating the third input value θᵢ by adding the high frequency output value θ_{mf} and the low frequency output value θ_{sf}. The cutoff frequency Cf3 in the low-pass filter processing is 30 Hz or less. Therefore, the frequency component of the third input value θᵢ in a frequency band higher than 30 Hz is a value obtained based on the rotation angle θₘ. As described above, according to the present example embodiment, even in a case where the model following control is performed using the third input value θ₁ obtained based on the rotation angle θₘ in a wide frequency band, it is possible to suppress deterioration in responsiveness of the lane keeping control as described above. Furthermore, for example, even if the communication cycle of the signals transmitted from the steering angle sensor 542 using the CAN is about 10 microseconds (ms), if the cutoff frequency Cf3 is 30 Hz or less, the model following control by the first model following controller 230 can be suitably executed.

In the present example embodiment, the phase delay element 216 may be a low-pass filter. In other words, the processing of delaying the phase in the phase delay compensation processing may be the first low-pass filter processing performed on the steering angle θₛ fed back in the lane keeping control. Even in this case, as described above, it is possible to suppress deterioration in responsiveness in the lane keeping control. Furthermore, in this case, the configuration of the phase delay element 216 can be simplified. In a case where the phase delay element 216 is a low-pass filter, the transfer function C_{fp}(s) of the phase delay element 216 is expressed by, for example, an expression obtained by replacing the numerator of the above-described Expression (5) with 1.

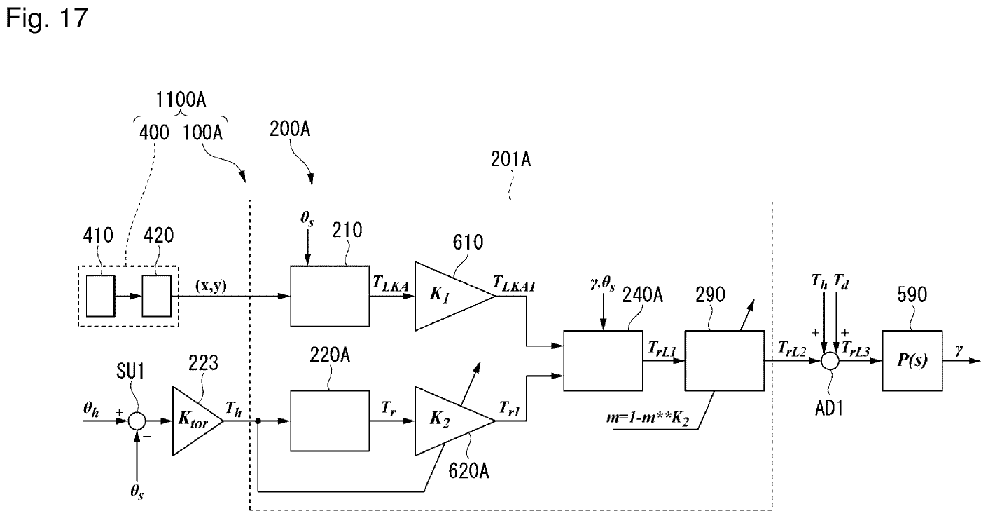

As illustrated in FIG. 17, a control device 100A of a lane keeping system 1100A of the present example embodiment is different from that of the first example embodiment in the configuration of a controller 201A of a processor 200A. In the present example embodiment, the steering torque Tₕ output from the torque conversion unit 223 is input to a second assist controller 220A. The second assist controller 220A is similar to the second assist controller 220 of the first example embodiment except that an input value is the steering torque Tₕ output from the torque conversion unit 223. The second command torque Tᵣ output from the second assist controller 220A is input to a second gain adjustment unit 620A. The second gain adjustment unit 620A is similar to the second gain adjustment unit 620 of the first example embodiment except that an input value is the second command torque Tᵣ output from the second assist controller 220A. The second gain adjustment unit 620A multiplies the second command torque Tᵣ by the second gain K₂ to obtain second command torque Tᵣ₁, and outputs the second command torque Tri to a vehicle stabilization controller 240A.

In the present example embodiment, the first command torque T_{LKA1} output from the first gain adjustment unit 610 is input only to the vehicle stabilization controller 240A. A command torque obtained by adding the first command torque T_{LKA1} and the second command torque Tri is input to the vehicle stabilization controller 240A. The other configurations of the vehicle stabilization controller 240A are similar to the other configurations of the vehicle stabilization controller 240 in the first example embodiment.

In the present example embodiment, the first command torque T_{LKA1} that is a first input value and the second command torque Tᵣ₁ that is a second input value are input to the vehicle stabilization controller 240A independently of each other. For this reason, an output from the first assist controller 210 adjusted by the first gain K₁ and an output from the second assist controller 220A adjusted by the second gain K₂ can be input to the vehicle stabilization controller 240A regardless of the other output. By the above, it is easy to adjust each control amount by each assist controller.

Note that, in the present description, “a first input value and a second input value are input to a vehicle stabilization controller independently of each other” means that, for example, the first input value and the second input value input to the vehicle stabilization controller are calculated regardless of the other input value.

The other configurations of the control device 100A are similar to the other configurations of the control device 100 in the first example embodiment. The other configurations of the lane keeping system 1100A are similar to the other configurations of the lane keeping system 1100 in the first example embodiment.

Note that, in the present example embodiment, a first input value output from the first assist controller 210 may be an angle. In this case, the first input value may be input to the vehicle stabilization controller 240A as an angle, or may be input to the vehicle stabilization controller 240A after being converted into a torque. In a case where the first input value is input to the vehicle stabilization controller 240A as an angle, a second input value output from the second assist controller 220A and input to the vehicle stabilization controller 240A is also an angle.

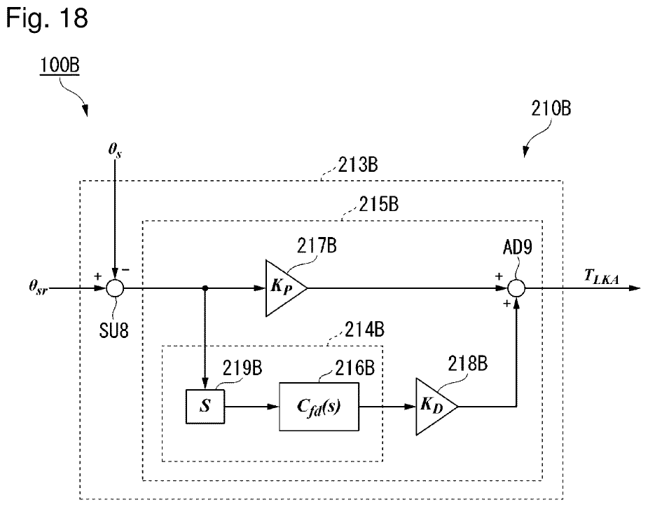

As illustrated in FIG. 18, in a first assist controller 210B of a control device 100B of the present example embodiment, a first generator 213B includes a torque calculator 215B and a subtractor SU8. In the present example embodiment, the first generator 213B generates the first command torque T_{LKA} by, for example, proportional-differential (PD) control. The subtractor SU8 subtracts the steering angle θₛ from the target steering angle θₛᵣ and outputs the result to the torque calculator 215B. The torque calculator 215B includes a compensator 214B, a proportional gain device 217B, a differential gain device 218B, and an adder AD9.

The target steering angle θₛᵣ input from the subtractor SU8 to the torque calculator 215B is input to the proportional gain device 217B and the compensator 214B. The proportional gain device 217B multiplies the input target steering angle θₛᵣ by the proportional gain K_{P} and outputs the result to the adder AD9. The compensator 214B includes a differentiator 219B and a phase advance element 216B. The target steering angle θₛᵣ input to the compensator 214B is input to the differentiator 219B. The target steering angle θₛᵣ input to the differentiator 219B is differentiated and input to the phase advance element 216B. The phase advance element 216B is a phase advance element that advances the phase of a value obtained by subtracting the steering angle θₛ from the target steering angle θₛᵣ. The transfer function C_{fd}(s) of the phase advance element 216B is expressed by, for example, Expression (21) below.

$$\begin{matrix}Expression 21 & \\ {C}_{f d} ( s ) = \frac{{τ}_{d z} s + 1}{{τ}_{d p} s + 1} & ( 21 )\end{matrix}$$

Here, s represents a Laplace transducer, and T_{dz} and T_{dp} represent time constants.

The value output from the phase advance element 216B is multiplied by the differential gain K_{D} in the differential gain device 218B and then input to the adder AD9. The adder AD9 adds the output from the proportional gain device 217B and the output from the differential gain device 218B to generate the first command torque T_{LKA}.

The other configurations of the first assist controller 210B are similar to the other configurations of the first assist controller 210 in the first example embodiment. The other configurations of the control device 100B are similar to the other configurations of the control device 100 in the first example embodiment.

According to the present example embodiment, the compensator 214B includes the phase advance element 216B that advances the phase of the value obtained by subtracting the steering angle θₛ from the target steering angle θₛᵣ. In other words, the phase delay compensation processing includes processing of advancing the phase of a value obtained by subtracting the steering angle θₛ from the target steering angle θₛᵣ. Therefore, the compensator 214B can compensate for the delay with respect to the rotation angle θₘ generated in the steering angle θₛ fed back to the first generator 213B. Therefore, it is possible to suppress deterioration in responsiveness of the lane keeping control.

Furthermore, in the present example embodiment, the phase advance element 216B is provided in a portion of the torque calculator 215B where differential control (D control) is performed. Therefore, the effect of further advancing the phase can be obtained by the differentiator 219B. As a result, it is possible to more suitably compensate for the delay with respect to the rotation angle θₘ generated at the steering angle θₛ by the phase advance element 216B and the differentiator 219B. Therefore, it is possible to further suppress deterioration in responsiveness of the lane keeping control.

At least a part of the function of each component of the control device according to each example embodiment described above may be implemented by hardware including a circuit unit such as a large scale integration (LSI), an application specific integrated circuit (ASIC), a field-programmable gate array (FPGA), and a graphics processing unit (GPU), or may be implemented by cooperation of software and hardware. A storage unit in which a program for causing the processor of the control device, which is a computer, to execute the above-described control method is stored is realized by, for example, a storage medium such as a random access memory (RAN), a read only memory (ROM), a hard disk drive (HDD), or a flash memory. The storage unit is not particularly limited as long as a program for causing a computer to execute the above-described control method can be stored, and may be a microcomputer or a disk medium such as a CD-ROM. The storage unit may be provided separately from the control device. In this case, the control device may communicate with the storage unit by wired communication or wireless communication and execute the program stored in the storage unit.

The present disclosure is not limited to the above-described example embodiment, and other configurations and other methods can be employed within the scope of the technical idea of the present disclosure. The phase delay compensation processing performed by the compensator may be any processing as long as the phase delay occurring in the fed back second output value (steering angle θₛ) can be compensated. The cutoff frequency in the high-pass filter processing performed by the calculator is the same as the cutoff frequency in the low-pass filter processing performed by the calculator. The cutoff frequency in the high-pass filter processing performed in the calculator and the cutoff frequency in the low-pass filter processing performed in the calculator are not particularly limited.

Note that example embodiments of the present disclosure can have any of the configurations as described below.

[1]A control device that controls, as a control target, a portion including a motor and a decelerator of an electric power steering device mounted on a vehicle, the electric power steering device including an input shaft to which a steering wheel to be steered by a steering operator is connected, an output shaft connected to the input shaft via a torsion bar, and the motor connected to the output shaft via the decelerator, the control device including a first assist controller configured or programmed to execute lane keeping control to keep the vehicle in a lane and generates a first input value, a second assist controller configured or programmed to generate a second input value based on a steering input value input from the steering wheel, and a disturbance sensitivity controller to which a command value calculated based on the first input value and the second input value is input, wherein the disturbance sensitivity controller is configured or programmed to include a model following controller configured or programmed to generate a correction value to correct the command value based on a nominal model based on a configuration of the control target, the model following controller is configured or programmed to include an inverse nominal model that is an inverse model of the nominal model and to which a third input value based on a first output value indicating an output of the motor is input, and the model following controller is configured or programmed such that a transfer function of the control target is constrained to a transfer function of the nominal model in a frequency band in which a complementary sensitivity gain is 1 or substantially 1, the complementary sensitivity gain being a gain in a gain characteristic of a complementary sensitivity function with respect to a modeling error between the control target and the nominal model, the first assist controller is configured or programmed to include a generator configured or programmed to generate the first input value based on a target value of an output of the decelerator, a second output value indicating an output of the decelerator is fed back to the generator, and the generator is configured or programmed to include a compensator configured or programmed to perform phase delay compensation processing on a phase delay generated in the second output value fed back.

[2] The control device according to [1], wherein the compensator includes a phase delay element to delay a phase of the second output value fed back to the generator.

[3] The control device according to [2], wherein the phase delay element includes a low-pass filter.

[4] The control device according to [1], wherein the compensator includes a phase advance element to advance a phase of a value obtained by subtracting the second output value from the target value.

[5] The control device according to any one of [1] to [4], further including a calculator configured or programmed to calculate the third input value by adding a value obtained by performing high-pass filter processing and division processing on the first output value, the division processing including dividing the first output value by a reduction ratio of the decelerator, and a value obtained by performing low-pass filter processing on the second output value, wherein a cutoff frequency in the low-pass filter processing is 30 Hz or less.

[6]A motor device including the control device according to any one of [1] to [5], and the motor.

[7] An electric power steering device including the motor device according to [6], and a steering mechanism including the input shaft, the output shaft, and the torsion bar.

[8]A control method of controlling, as a control target, a portion including a motor and a decelerator of an electric power steering device mounted on a vehicle, the electric power steering device including an input shaft to which a steering wheel to be steered by a steering operator is connected, an output shaft connected to the input shaft via a torsion bar, and the motor connected to the output shaft via the decelerator, the control method including generating a first input value and executing lane keeping control to keep the vehicle in a lane, generating a second input value based on a steering input value input from the steering wheel, executing a model following control to generate a correction value to correct a command value calculated based on the first input value and the second input value, based on a nominal model based on a configuration of the control target, and constraining a transfer function of the control target to a transfer function of the nominal model in a frequency band in which a complementary sensitivity gain is 1 or substantially 1 by the model following control, the complementary sensitivity gain being a gain in a gain characteristic of a complementary sensitivity function with respect to a modeling error between the control target and the nominal model, wherein in the model following control, a third input value based on a first output value indicating an output of the motor is input to an inverse nominal model that is an inverse model of the nominal model, and the lane keeping control includes generating the first input value based on a target value of an output of the decelerator, feeding back a second output value indicating an output of the decelerator, and performing phase delay compensation processing on a phase delay generated in the second output value fed back.

[9] The control method according to [8], wherein the phase delay compensation processing includes processing of delaying a phase of the second output value fed back in the lane keeping control.

[10] The control method according to [9], wherein the processing of delaying the phase is first low-pass filter processing performed on the second output value fed back in the lane keeping control.

[11] The control method according to [8], wherein the phase delay compensation processing includes processing of advancing a phase of a value obtained by subtracting the second output value from the target value.

[12] The control method according to any one of [8] to [11], further including calculating the third input value by adding a value obtained by performing high-pass filter processing and division processing on the first output value, the division processing including dividing the first output value by a reduction ratio of the decelerator, and a value obtained by performing second low-pass filter processing on the second output value, wherein a cutoff frequency in the second low-pass filter processing is about 30 Hz or less.

[13]A non-transitory computer-readable medium including a program executable to cause a computer to perform the control method according to any one of [8] to [12].

The configurations and methods described above in the present description can be appropriately combined within a range consistent with each other.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A control device that controls, as a control target, a portion including a motor and a decelerator of an electric power steering device mounted on a vehicle, the electric power steering device including an input shaft to which a steering wheel to be steered by a steering operator is connected, an output shaft connected to the input shaft via a torsion bar, and the motor connected to the output shaft via the decelerator, the control device comprising:
a first assist controller configured or programmed to execute lane keeping control to keep the vehicle in a lane and generates a first input value;
a second assist controller configured or programmed to generate a second input value based on a steering input value input from the steering wheel; and
a disturbance sensitivity controller to which a command value calculated based on the first input value and the second input value is input; wherein
the disturbance sensitivity controller is configured or programmed to include a model following controller configured or programmed to generate a correction value to correct the command value based on a nominal model based on a configuration of the control target;
the model following controller is configured or programmed to include an inverse nominal model that is an inverse model of the nominal model and to which a third input value based on a first output value indicating an output of the motor is input, and the model following controller is configured or programmed such that a transfer function of the control target is constrained to a transfer function of the nominal model in a frequency band in which a complementary sensitivity gain is 1 or substantially 1, the complementary sensitivity gain being a gain in a gain characteristic of a complementary sensitivity function with respect to a modeling error between the control target and the nominal model;
the first assist controller is configured or programmed to include a generator configured or programmed to generate the first input value based on a target value of an output of the decelerator;
a second output value indicating an output of the decelerator is fed back to the generator; and
the generator includes a compensator configured or programmed to perform phase delay compensation processing on a phase delay generated in the second output value fed back.

2. The control device according to claim 1, wherein the compensator includes a phase delay element to delay a phase of the second output value fed back to the generator.

3. The control device according to claim 2, wherein the phase delay element includes a low-pass filter.

4. The control device according to claim 1, wherein the compensator includes a phase advance element to advance a phase of a value obtained by subtracting the second output value from the target value.

5. The control device according to claim 1, further comprising a calculator configured or programmed to calculate the third input value by adding a value obtained by performing high-pass filter processing and division processing on the first output value, the division processing including dividing the first output value by a reduction ratio of the decelerator, and a value obtained by performing low-pass filter processing on the second output value, wherein a cutoff frequency in the low-pass filter processing is about 30 Hz or less.

6. A motor device comprising:
the control device according to claim 1; and
the motor.

7. An electric power steering device comprising:
the motor device according to claim 6; and
a steering mechanism including the input shaft, the output shaft, and the torsion bar.

8. A control method of controlling, as a control target, a portion including a motor and a decelerator of an electric power steering device mounted on a vehicle, the electric power steering device including an input shaft to which a steering wheel to be steered by a steering operator is connected, an output shaft connected to the input shaft via a torsion bar, and the motor connected to the output shaft via the decelerator, the control method comprising:
generating a first input value and executing lane keeping control to keep the vehicle in a lane;
generating a second input value based on a steering input value input from the steering wheel;
executing model following control to generate a correction value to correct a command value calculated based on the first input value and the second input value, based on a nominal model based on a configuration of the control target; and
constraining a transfer function of the control target to a transfer function of the nominal model in a frequency band in which a complementary sensitivity gain is 1 or substantially 1 by the model following control, the complementary sensitivity gain being a gain in a gain characteristic of a complementary sensitivity function with respect to a modeling error between the control target and the nominal model; wherein
in the model following control, a third input value based on a first output value indicating an output of the motor is input to an inverse nominal model that is an inverse model of the nominal model; and
the lane keeping control includes:
generating the first input value based on a target value of an output of the decelerator;
feeding back a second output value indicating an output of the decelerator; and
performing phase delay compensation processing on a phase delay generated in the second output value fed back.
